(19) United States
(12) Patent Application Publication
(10) Pub. No.: US 2014/0059249 A1
(43) Pub. Date: Feb. 27, 2014

(54) DATA CONVERSION DEVICE, DATA CONVERSION METHOD, AND PROGRAM FOR DATA CONVERSION

(71) Applicant: Kazutoshi Kashimoto, Kanagawa (JP)

(72) Inventor: Kazutoshi Kashimoto, Kanagawa (JP)

(73) Assignee: PANASONIC CORPORATION, Osaka (JP)

(21) Appl. No.: 13/988,398

(22) PCT Filed: Oct. 17, 2012
(86) PCT No.: PCT/JP2012/006634

§ 371 Date: May 20, 2013

(30) Foreign Application Priority Data
Nov. 14, 2011 (JP) 2011-248326

(51) Int. Cl. H04L 29/08

(52) U.S. Cl. CPC H04L 29/08756
USPC 709/246

(57) ABSTRACT

When an information storing area included only in a first data format among the first data format corresponding to a version of processing target data and a second data format corresponding to an output version is present as a difference area, a data conversion device 110 converts information data in the difference area in the processing target data to a post-conversion character string using codes for non-display characters, and generates post-conversion data of the output version in which the post-conversion character string is embedded. When an information storing area included only in the second data format is present as a difference area, the data conversion device 110 inversely converts a character string embedded in the processing target data and uses the codes for the non-display characters, and generates post-inverse conversion data of the output version in which information data restored by the inverse conversion is stored in the difference area.

### TECHNICAL FIELD

The present invention relates to a data conversion device that converts processing target data to another version.

### BACKGROUND ART

In recent years, cases have been increased in which a plurality of apparatuses are caused to communicate with each other, for example, wirelessly to perform transmission/reception of data therebetween.

For example, audio-visual (AV)-related digital home electrical appliances are enabled to cooperate with each other and perform transmission/reception of data therebetween by a technology such as DLNA (Digital Living Network Alliance) or Bluetooth (registered trademark). Digital home electrical appliances are information apparatuses such as televisions, PCs, AV players, and HDD recorders. Information apparatuses are able to seamlessly share digital contents such as music, pictures, and moving images by performing transmission/reception of data therebetween.

In an information apparatus, for example, an OS (operating system) on the information apparatus itself and an application program running on the OS operate, whereby data is utilized. When transmission/reception of data is performed between a plurality of information apparatuses, the version of a program installed in each information apparatus may be different from those in the other information apparatuses. In such a case, data formats used in different versions of the program may be different from each other, and thus it may be impossible to utilize data transmitted from another apparatus.

A method has been proposed in which in a situation where it is possible to use a plurality versions of a program, namely, new and old versions of a program, a file or the like in a new information format is allowed to be inputted with the old version program on a plurality of computers (e.g., see Patent Literature 1). In this method, a function to downgrade the new information format to an old information format is added to the input function of the old version program, whereby the old version program allows the new information format to be inputted.

### CITATION LIST

### Patent Literature

[PTL 1] Japanese Laid-Open Patent Publication No. H10-11271

### SUMMARY OF THE INVENTION

### Problems to be Solved by the Invention

However, the above conventional configuration has a problem that in downgrading the new information format to the old information format, information on an item that is newly added in the new information format is lost.

The present invention provides a data conversion device that is able to suppress deterioration of convenience, provided by version upgrade or the like, in data conversion between versions whose data formats are different from each other.

### Solution to the Problems

In order to solve the above-described problem of the conventional art, a data conversion device according to an aspect of the present invention includes: a code storage section configured to store therein a conversion rule which uses codes for non-display characters to which no character is allocated; a conversion section configured to perform, when an information storing area included only in a first data format among the first data format corresponding to an input version which is a version of processing target data and a second data format corresponding to an output version to which the processing target data is converted by the data conversion device is present as a difference area, a conversion process of converting information data stored in the difference area in the processing target data to a post-conversion character string using the codes for the non-display characters, on the basis of the conversion rule, and generating post-conversion data of the output version in which the post-conversion character string is embedded; an inverse conversion section configured to perform, when an information storing area included only in the second data format among the first data format and the second data format is present as a difference area, an inverse conversion process of inversely converting a character string that is embedded in the processing target data and uses the codes for the non-display characters, on the basis of the conversion rule, and then generating post-inverse conversion data of the output version in which information data restored by the inverse conversion is stored in the difference area; and a control section configured to control the conversion section and the inverse conversion section.

### Advantageous Effects of the Invention

According to the data conversion device according to the aspect of the present invention, it is possible to provide a data conversion device that is able to suppress deterioration of convenience, provided by version upgrade or the like, in data conversion between versions whose data formats are different from each other.

### BRIEF DESCRIPTION OF THE DRAWINGS

FIG. 1 is a diagram showing an example of the configuration of a communication system according to Embodiment 1.

FIG. 2 is a diagram showing an example of the hardware configuration of an information apparatus including a data conversion device according to Embodiment 1.

FIG. 3 is a block diagram showing an example of the configuration of the information apparatus including the data conversion device according to Embodiment 1.

FIG. 4 is a diagram showing an example of target data stored by a data storage section according to Embodiment 1.

FIG. 5 is a diagram showing an example of data format information stored by a version information storage section according to Embodiment 1.

FIG. 6 is a diagram showing an example of a conversion rule stored by a code storage section according to Embodiment 1.

FIG. 7 is a sequence diagram showing an example of a data-sharing process in which an information apparatus A according to Embodiment 1 transmits target data to an information apparatus B.

FIG. 8 is a flowchart showing an example of a data conversion process performed by the data conversion device according to Embodiment 1.

FIG. 9 is a diagram showing an example of difference data and an embedded destination of the difference data in Embodiment 1.

FIG. 10 is a diagram showing an example of a procedure for a conversion process using codes for non-display characters by a conversion section according to Embodiment 1.

FIG. 11 is a diagram showing an example of change of data when the information apparatus including the data conversion device according to Embodiment 1 transmits post-conversion data to another information apparatus.

FIG. 12 is a sequence diagram showing an example of a data-sharing process in which the information apparatus A according to Embodiment 1 receives target data from the information apparatus B.

FIG. 13 is a diagram showing an example of change of data when the information apparatus including the data conversion device according to Embodiment 1 receives post-conversion data from another information apparatus.

FIG. 14 is a block diagram showing an example of the configuration of an information apparatus including a data conversion device according to Embodiment 2.

FIG. 15 is a diagram showing an example of data format information stored by a second version information storage section according to Embodiment 2.

FIG. 16 is a sequence diagram showing an example of a data-sharing process in which the information apparatus including the data conversion device according to Embodiment 2 performs transmission/reception of data with another information apparatus.

FIG. 17 is a flowchart showing an example of a data conversion process performed by the data conversion device according to Embodiment 2.

FIG. 18 is a diagram showing an example of change of bookmark information during the data-sharing process according to Embodiment 2.

FIG. 19 is a diagram showing an example of data format information when information other than bookmark information is set as target data.

### DESCRIPTION OF EMBODIMENTS

Hereinafter, embodiments of an aspect of the present invention will be described with reference to the drawings.

### Embodiment 1

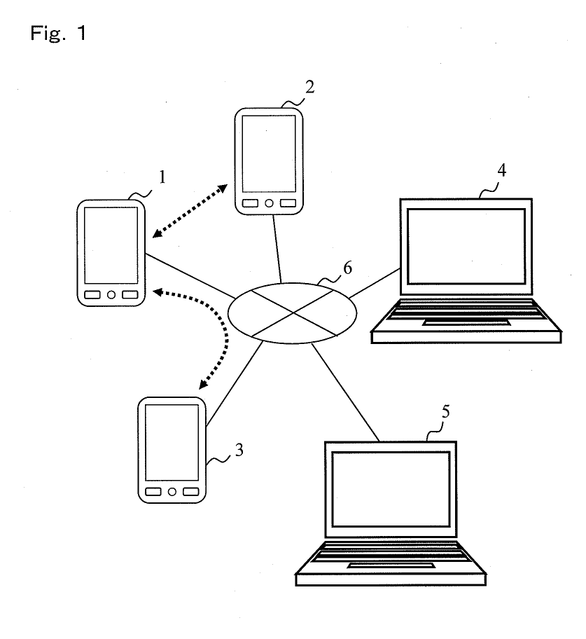

FIG. 1 is a diagram showing an example of the configuration of a communication system according to the present embodiment. A plurality of information apparatuses 1 to 5 establish connections to each other via a network 6.

Each of the information apparatuses 1 to 5 has at least either a short-range communication function or a wide-area communication function. As the short-range communication function, a wireless communication function using Bluetooth (registered trademark), infrared communication, a wireless LAN, or the like is applicable, and a wired communication function using a USB, Ethernet (registered trademark), or the like is also applicable. In addition, a communication function via a public network such as the Internet or a public telephone line is applicable as the wide-area communication function.

The information apparatuses 1 to 5 are portable information terminals such as mobile PCs, mobile phones, smart phones, tablet terminals, digital cameras, and portable music players. Alternatively, the information apparatuses 1 to 5 may be AV apparatuses such as televisions, AV players, and HDD recorders. Still alternatively, each information apparatus may be an information communication terminal such as a desktop PC. The information apparatuses 1 to 5 establish connections to each other via the network 6 and perform transmission/reception of data therebetween, whereby data stored in the information apparatuses 1 to 5, which are communication partners, is allowed to be received and utilize by each information apparatus itself.

Each of the information apparatuses 1 to 5 is provided with software for utilizing data. However, when versions of a program used in the information apparatuses 1 to 5 which perform transmission/reception of data therebetween are different from each other and data formats used in the different versions of the program are different from each other, it may be impossible for the information apparatuses 1 to 5 to mutually utilize the same data. In this case, the information apparatuses 1 to 5 cannot utilize data received from the information apparatuses 1 to 5, which are communication partners provided with the different versions of the program, without changing the data. Thus, it is necessary to convert the version of data that is desired to be used.

However, in a conventional data conversion device, an editing target of an old version program is data in an old information format and does not include information on an item that is newly added in a new version. An apparatus provided with the old version program has a problem that information on the item that is newly added in the new version is not kept.

A data conversion device according to an embodiment of an aspect of the present invention which solves such a problem performs a data conversion process of converting processing target data to another version whose data format is different from that of the processing target data. An information apparatus that includes the data conversion device according to the present embodiment is allowed to utilize data received from an apparatus that is a communication partner provided with a program whose version is different from that of a program installed in the information apparatus. In the conversion process of converting to a data format of a different version, the data conversion device embeds, in post-conversion data, difference data based on a difference in data format. The difference data is stored in a state where the difference data is restorable by inverse conversion.

A data conversion device according to a first aspect includes: a code storage section configured to store therein a conversion rule which uses codes for non-display characters to which no character is allocated; a conversion section configured to perform, when an information storing area included only in a first data format among the first data format corresponding to an input version which is a version of processing target data and a second data format corresponding to an output version to which the processing target data is converted by the data conversion device is present as a difference area, a conversion process of converting information data stored in the difference area in the processing target data to a post-conversion character string using the codes for the non-display characters, on the basis of the conversion rule, and generating post-conversion data of the output version in which the post-conversion character string is embedded; an inverse conversion section configured to perform, when an information storing area included only in the second data format among the first data format and the second data format is present as a difference area, an inverse conversion process of inversely converting a character string that is embedded in the processing target data and uses the codes for the non-display characters, on the basis of the conversion rule, and then generating post-inverse conversion data of the output version in which information data restored by the inverse conversion is stored in the difference area; and a control section configured to control the conversion section and the inverse conversion section.

In the data conversion device according to the first aspect, the post-conversion character string to which the information data in the difference area determined based on the difference in data format is converted is embedded in the post-conversion data that has been subjected to the conversion process. The data conversion device embeds, in the post-conversion data, the character string using the codes for the non-display characters. Thus, even when an image based on the post-conversion data is displayed on a screen of the information apparatus, the non-display characters obtained by converting the post-conversion character string within the post-conversion data are not displayed. Therefore, it is possible for the user to utilize the post-conversion data without recognizing the post-conversion character string.

In addition, the data conversion device according to the first aspect performs the inverse conversion process of returning the post-conversion data to the data format of the original version. The post-conversion character string to which the information data in the difference area determined based on the difference in data format is converted is embedded in the post-conversion data. Thus, by the inverse conversion process, the original information data is allowed to be restored from the post-conversion character string. The information apparatus is allowed to reutilize the information data in the difference area by utilizing the restored information data.

In a data conversion device according to a second aspect based on the first aspect, the control section instructs the conversion section to perform the conversion process when the control section determines execution of the conversion process on the basis of the input version; and instructs the inverse conversion section to perform the inverse conversion process when the control section determines execution of the inverse conversion process on the basis of the input version. According to the data conversion device according to the second aspect, the data conversion device automatically determines whether to perform the conversion process and whether to perform the inverse conversion process, and thus it is possible to eliminate the necessity for the user to select a process to be performed.

A data conversion device according to a third aspect based on the first or second aspect further includes a version information storage section configured to store therein data format information indicating the first data format, the data format information includes embeddability information indicating whether it is possible to embed the post-conversion character string, and when the control section determines, on the basis of the embeddability information, that it is impossible to embed the post-conversion character string, the control section does not instruct the conversion section to perform the conversion process.

In a data conversion device according to a fourth aspect based on any one of the first to third aspects, in the conversion process, the conversion section embeds the post-conversion character string in an information storing area in which, by a target program which generates, on the basis of the processing target data, an image to be displayed on a screen, information data used only for generating information on the image based on the processing target data is stored. According to the data conversion device according to the fourth aspect, a computer that executes the target program is allowed to operate without causing a malfunction due to the post-conversion character string embedded in the post-conversion data.

In a data conversion device according to a fifth aspect based on any one of the first to fourth aspects, the control section compares the input version and the output version to each other, instructs the conversion section to perform the conversion process when the input version is newer than the output version, and instructs the inverse conversion section to perform the inverse conversion process when the input version is older than the output version.

A data conversion device according to a sixth aspect based on any one of the first to fifth aspects further includes a version information storage section configured to store therein data format information indicating the first data format and data format information indicating the second data format; and, in the conversion process, the conversion section converts information data extracted from the difference area in the processing target data by using each of the data format information stored in the version information storage section, to the post-conversion character string.

A data conversion device according to a seventh aspect based on any one of the first to fifth aspects further includes a version information storage section configured to store therein data format information indicating the first data format and data format information indicating the second data format; and, in the inverse conversion process, the inverse conversion section inversely converts a character string that is extracted from the processing target data by using each of the data format information stored in the version information storage section and uses the codes for the non-display characters.

In a data conversion device according to an eighth aspect based on the third aspect, the processing target data is data in a database format, the version information storage section stores therein data format information of the database format including one or more columns, and the data format information includes the embeddability information for each column.

In a data conversion device according to a ninth aspect based on any one of the first to eighth aspects, the code storage section stores therein, as the conversion rule, a code conversion table in which the codes for the non-display characters and binary number strings correspond to each other.

In a data conversion device according to a tenth aspect based on any one of the first to ninth aspects, when the processing target data is bookmark information used in a program for browsing through a web browser, the conversion section embeds the post-conversion character string in an information storing area in which data of a title of a web page in the bookmark information is stored.

In a data conversion device according to an eleventh aspect based on any one of the first to ninth aspects, when the processing target data is history information used in a program for browsing through a web browser, the conversion section embeds the post-conversion character string in an information storing area in which data of a title of a web page in the history information is stored.

In a data conversion device according to a twelfth aspect based on any one of the first to ninth aspects, when the processing target data is schedule information used in a schedule management program, the conversion section embeds the post-conversion character string in an information storing area in which data of a matter or a task in the schedule information is stored.

In a data conversion device according to a thirteenth aspect based on any one of the first to ninth aspects, when the processing target data is e-mail history information used in an e-mail program, the conversion section embeds the post-conversion character string in an information storing area in which data of a subject or an e-mail text in the e-mail history information is stored.

In a data conversion device according to a fourteenth aspect based on any one of the first to ninth aspects, when the processing target data is schedule information used in a program for schedule management, the conversion section embeds the post-conversion character string in an information storing area in which a subject of a schedule in the schedule information is stored.

An information apparatus according to a fifteenth aspect includes: the data conversion device according to any one of the first to fourteenth aspects; and a processing section configured to instruct the data conversion device to perform the conversion process and to perform the inverse conversion process.

In an information apparatus according to a sixteenth aspect based on the fifteenth aspect, the data conversion device further includes a version information storage section configured to store therein data format information indicating a data format of a self-apparatus version which is used by the self-apparatus, and when the control section receives an instruction for the conversion process on the processing target data from the processing section, the control section extracts information data in the difference area from the processing target data by using the processing target data and the data format of the self-apparatus version, and instructs the conversion section to perform the conversion process on the extracted information data.

In an information apparatus according to a seventeenth aspect based on the fifteenth aspect, the data conversion device further includes a version information storage section configured to store therein data format information indicating a data format of a self-apparatus version which is used by the self-apparatus, and when the control section receives an instruction for the inverse conversion process on the processing target data from the processing section, the control section extracts an entirety of a character string using the non-display characters, as embedded data from the processing target data, and instructs the inverse conversion section to perform the inverse conversion process on the extracted embedded data.

A data conversion method according to an eighteenth aspect is a data conversion method for converting processing target data to another version whose data format is different from that of the processing target data. The data conversion method includes: a conversion step of, when an information storing area included only in a first data format among the first data format corresponding to an input version which is a version of the processing target data and a second data format corresponding to an output version to which the processing target data is converted by the data conversion method is present as a difference area, converting, on the basis of a conversion rule which uses codes for non-display characters to which no character is allocated, information data stored in the difference area in the processing target data to a post-conversion character string using the codes for the non-display characters, and generating post-conversion data of the output version in which the post-conversion character string is embedded; and an inverse conversion step of, when an information storing area included only in the second data format among the first data format and the second data format is present as a difference area, inversely converting a character string that is embedded in the processing target data and uses the codes for the non-display characters, on the basis of the conversion rule, and then generating post-inverse conversion data of the output version in which information data restored by the inverse conversion is stored in the difference area.

A program according to a nineteenth aspect is a program for causing a computer to perform a data conversion process of converting processing target data to another version whose data format is different from that of the processing target data. The program causes the computer to execute: a conversion step of, when an information storing area included only in a first data format among the first data format corresponding to an input version which is a version of the processing target data and a second data format corresponding to an output version to which the processing target data is converted by the data conversion process is present as a difference area, converting, on the basis of a conversion rule which uses codes for non-display characters to which no character is allocated, information data stored in the difference area in the processing target data to a post-conversion character string using the codes for the non-display characters, and generating post-conversion data of the output version in which the post-conversion character string is embedded; and an inverse conversion step of, when an information storing area included only in the second data format among the first data format and the second data format is present as a difference area, inversely converting a character string that is embedded in the processing target data and uses the codes for the non-display characters, on the basis of the conversion rule, and then generating post-inverse conversion data of the output version in which information data restored by the inverse conversion is stored in the difference area.

[Information Apparatus]

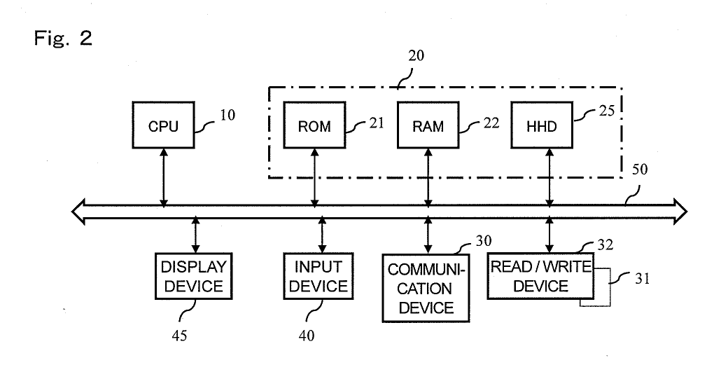

FIG. 2 is a diagram showing the hardware configuration of the information apparatus that includes the data conversion device according to the present embodiment.

The information apparatus includes a CPU (Central Processing Unit) 10, a memory device 20, a communication device 30, a read/write device 32, an input device 40, and a display device 45. These devices are connected to each other via a bus line 50.

The CPU 10 serves as a central processing section. The central processing section may be composed of a single CPU or may be composed of a plurality of CPUs. FIG. 2 shows an example in which the central processing section includes the single CPU 10.

The memory device 20 includes a ROM (Read Only Memory) 21, a RAM (Random Access Memory) 22, and an HDD (hard disc drive) 25. The ROM 21 stores therein a computer program that specifies operation of the CPU 10, and its data. While writing a computer program and its data, stored in the ROM 21 or the HDD 25, into the RAM 22 according to need, the CPU 10 performs a process specified by the computer program. The RAM 22 also serves as a medium that temporarily stores therein data generated when the CPU 10 performs the process. The memory device 20 includes a storage medium and a nonvolatile memory, such as a flash memory, which is writable and is able to retain a stored content even when the information apparatus is turned off. The information apparatus stores therein data that is to be transmitted to or is received from another information apparatus, into the nonvolatile memory or the storage medium included in the memory device 20.

The read/write device 32 is a device that has a function to read data recorded in a portable storage medium 31 (e.g., a USB memory or a memory card such as an SD card) and a function to write data into the portable storage medium 31. The information apparatus is able to store data that is to be transmitted to or is received from another information apparatus, into the portable storage medium 31 by using the read/write device 32.

The communication device 30 is a device that performs transmission/reception of data with an external device via a wired or wireless communication line. As described above, the information apparatus has at least either a short-range communication function or a wide-area communication function. As the short-range communication function, a wireless communication function using Bluetooth (registered trademark), infrared communication, a wireless LAN, or the like is applicable, and a wired communication function using a USB, Ethernet (registered trademark), or the like is also applicable. A communication function via a public network such as the Internet or a public telephone line is applicable as the wide-area communication function.

The input device 40 is a device that receives an input operation of the user, and is, for example, a touch panel, an input button, an operation key, a mouse, and a keyboard. In addition, the input device 40 may be a remote controller for the information apparatus. In this case, the input device 40 is not directly connected to the bus line 50.

The display device 45 is a device that displays an image or video on a screen thereof, and is, for example, an LCD (Liquid Crystal Display) and a speaker. The display device 45 may have a function to output a sound corresponding to an image or video displayed on the screen.

As described above, the information apparatus is configured as a computer. It is possible to supply the above computer program to the information apparatus through the ROM 21 or the portable storage medium 31 or through a transmission media such as a communication line 33. For example, the computer program recorded in the portable storage medium 31 is allowed to be read when the read/write device 32 is connected to the information apparatus. In addition, the read computer program is allowed to be stored into the RAM 22.

When the computer program is supplied through the ROM 21 as a program storage medium, the CPU 10 is able to perform a process according to the computer program, since the information apparatus includes the ROM 21. The computer program supplied through a transmission medium such as the communication line 33 is received through the communication device 30 and stored, for example, into the RAM 22.

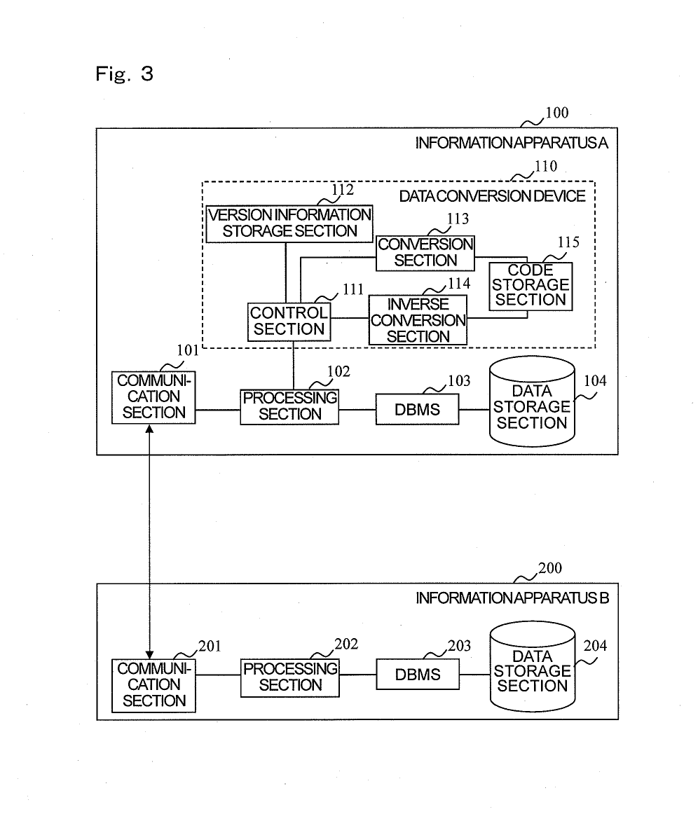

Hereinafter, a description will be given on the assumption that target data to be shared by the information apparatus and another information apparatus has been already stored in the memory device 20 of the information apparatus or the portable storage medium 31. The information apparatus is provided with a target program for utilizing the target data. In addition, different versions of the target program are different from each other in used data format and cannot utilize the same data. It is noted that the data format of the target data is different depending on the version of the target program.

[Information Apparatus a and Information Apparatus B in FIG. 3]

FIG. 3 is a block diagram showing the configuration of an information apparatus that includes a data conversion device 110 according to the present embodiment.

FIG. 3 shows an example in which transmission/reception of data is performed between two information apparatuses. One of the two information apparatus is referred to as an information apparatus A100, and the other is referred to as an information apparatus B200. The information apparatus A100 includes the data conversion device 110 according to an aspect of the present invention.

The information apparatus A100 and the information apparatus B200 are provided with the same target program (different versions of the same program) and have stored therein target data to be utilized by the target program, in a database format that allows data corresponding to specific items to be collected. The information apparatus A100 and the information apparatus B200 perform transmission/reception of the target data, stored in the database format, therebetween to share the target data. The different versions of the target program may be different from each other in used data format (item in the database format) and may not be able to utilize the same data.

A detailed description will be given by means of a specific example. The target program is a web browser application. The target data stored in the database format is data of bookmark information. It is noted that in the web browser application, the target data to be shared by a plurality of information apparatuses may be other data such as history information that is a collection of user's browsing histories. Alternatively, the target program may be another program such as an e-mail application or a schedule application. In this case, the target data to be shared is other data such as address book data or schedule data.

The information apparatus A100 includes the data conversion device 110, a communication section 101, a processing section 102, a database management system (hereinafter, referred to as DBMS) 103, and a data storage section 104.

The communication section 101 performs a process of transmitting data and a process of receiving data via a network. The communication section 101 corresponds to the communication device 30 in FIG. 2 and operates according to instructions from a program that runs on the CPU 10.

The data storage section 104 is a memory that stores therein the target data in the database format which is utilized by the target program that runs on the information apparatus A100. The target data in the database format is data of bookmark information. The data storage section 104 corresponds to the memory device 20 in FIG. 2. It is noted that when the information apparatus A100 is able to utilize an external memory as a storage area for the bookmark information, the portable storage medium 31 may be used as the data storage section 104.

The DBMS 103 accesses the data storage section 104 and controls writing and reading of the target data in the database format and the like.

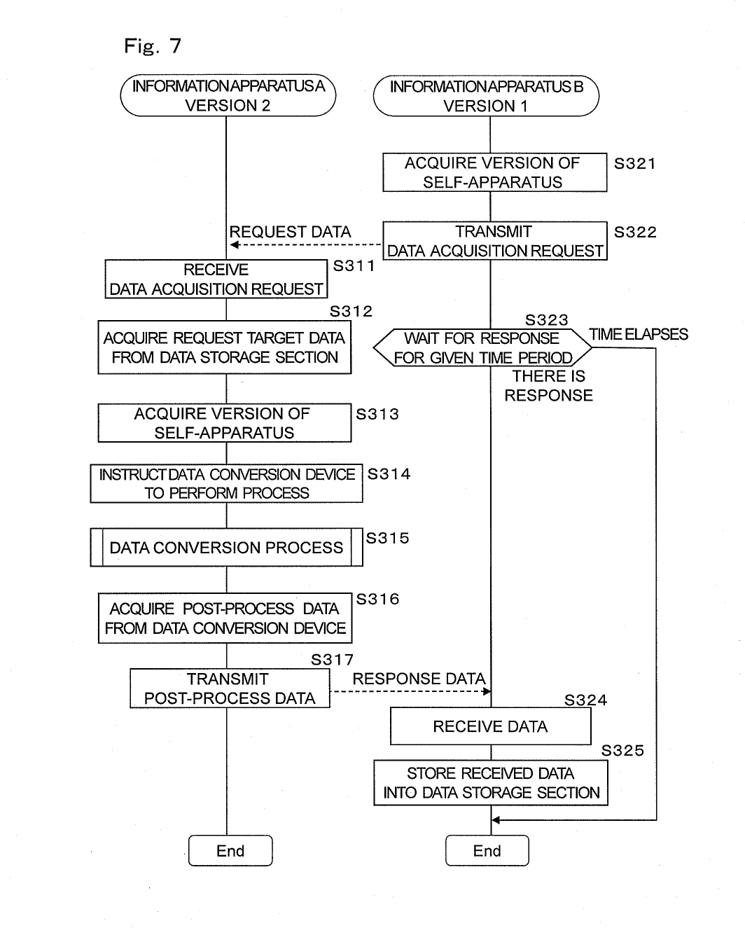

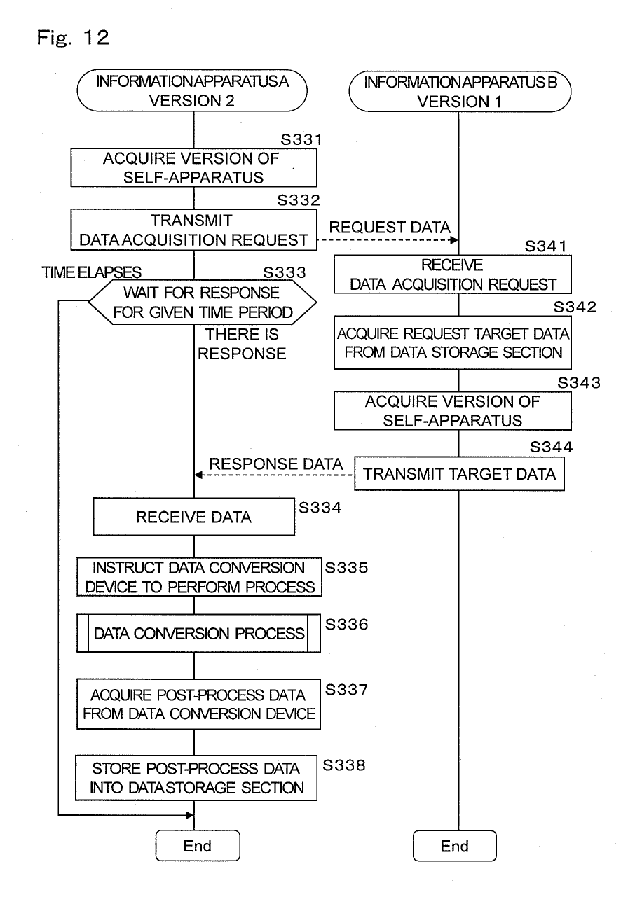

The processing section 102 controls a data-sharing process for sharing, with another information apparatus, the target data in the database format which is utilized by the target program of the information apparatus A100 (self-apparatus). The processing section 102 corresponds to the CPU 10 which operates according to the program stored in the memory device 20 in FIG. 2. As shown in FIG. 7 described later, the processing section 102 reads the target data (target data supporting the version of the target program installed in the information apparatus A100) from the data storage section 104 through the DBMS 103, and instructs the data conversion device 110 to perform a data conversion process with the read data as processing target data. Then, the processing section 102 transmits post-process data (post-conversion data or post-inverse conversion data) outputted by the data conversion device 110, through the communication section 101 to an information apparatus that is a communication partner. In addition, as shown in FIG. 12 described later, the processing section 102 instructs the data conversion device 110 to perform a data conversion process with, as processing target data, target data received through the communication section 101 from the information apparatus that is the communication partner. Then, the processing section 102 writes post-process data outputted by the data conversion device 110, into the data storage section 104 through the DBMS 103.

The data conversion device 110 receives the instruction from the processing section 102 and performs a conversion process to a data format of a different version (a forward conversion process). The data conversion device 110 converts the processing target data (target data before conversion) to an output version different from the version of the processing target data. A first data format corresponding to an input version that is the version of the processing target data is different from a second data format corresponding to the output version. In the conversion process, in the case of a first state where an information storing area included only in the first data format among the first data format and the second data format is present as a difference area, the data conversion device 110 generates post-conversion data in which a post-conversion character string to which information data (difference data) stored in the difference area in the processing target data is converted is embedded. The post-conversion data allows the original information data (the information data stored in the difference area) to be restored by inversely converting the embedded post-conversion character string. It is noted that in the conversion process, in the case of a second state where an information storing area included only in the second data format among the first data format and the second data format is present as a difference area, the data conversion device 110 performs an inverse conversion process.

The information apparatus B200 includes a communication section 201, a processing section 202, a database management system (hereinafter, referred to as DBMS) 203, and a data storage section 204.

The communication section 201 performs a process of transmitting data and a process of receiving data via a network. The communication section 201 corresponds to the communication device 30 in FIG. 2 and operates according to instructions from a program that runs on the CPU 10.

The data storage section 204 is a memory that stores therein the target data in the database format which is utilized by the target program that runs on the information apparatus B200. The target data in the database format is data of bookmark information. The data storage section 204 corresponds to the memory device 20 in FIG. 2. It is noted that when the information apparatus B200 is able to utilize an external memory as a storage area for the bookmark information, the portable storage medium 31 may be used as the data storage section 204.

The DBMS 203 accesses the data storage section 204 and controls writing and reading of the target data in the database format and the like.

The processing section 202 controls a data-sharing process for sharing, with another information apparatus, the target data in the database format which is utilized by the target program of the information apparatus B200 (self-apparatus). The processing section 202 corresponds to the CPU 10 which operates according to the program stored in the memory device 20 in FIG. 2. As shown in FIG. 12 described later, the processing section 202 reads the target data (target data supporting the version of the target program installed in the information apparatus B200) from the data storage section 204 through the DBMS 203, and transmits the read target data through the communication section 201 to an information apparatus that is a communication partner. In addition, as shown in FIG. 7 described later, the processing section 202 receives target data through the communication section 201 from the information apparatus that is the communication partner, and writes the received target data into the data storage section 204 through the DBMS 203.

[Data Conversion Device]

Subsequently, the data conversion device 110 of the information apparatus A100 will be described. The data conversion device 110 includes a control section 111, a version information storage section 112, a conversion section 113, an inverse conversion section 114, and a code storage section 115.

The control section 111 receives an instruction from the processing section 102 and controls a data conversion process of converting the target data to a data format of a different version. The control section 111 corresponds to the CPU 10 which operates according to the program stored in the memory device 20 in FIG. 2. The control section 111 receives, from the processing section 102, an input version and an output version to which the processing target data is converted through the data conversion process. As shown in FIG. 7 described later, when the target data is transmitted from the information apparatus A100 to the information apparatus B200, the input version is the version of the target data stored in the data storage section 104, namely, the version of the bookmark information used by the information apparatus A100. The output version is the version of the bookmark information used by the information apparatus B200.

In addition, as shown in FIG. 12 described later, when the information apparatus A100 receives the target data from the information apparatus B200, the input version is the version of the target data received from the information apparatus B200, namely, the version of the bookmark information used by the information apparatus B200. The output version is the version of the target data stored in the data storage section 104, namely, the version of the bookmark information used by the information apparatus A100.

The control section 111 compares the input version and the output version to each other and determines a process to be performed. When the input version is newer than the output version, the control section 111 instructs the conversion section 113 to perform the conversion process (forward conversion process). As a result, the conversion section 113 generates the output version of the target data (post-conversion data). On the other hand, when the output version is newer than the input version, the control section 111 instructs the inverse conversion section 114 to perform the inverse conversion process. As a result, the inverse conversion section 114 generates the output version of the target data (post-inverse conversion data). When the input version and the output version are the same, the control section 111 determines that version conversion of data is not to be performed, and notifies the processing section 102 of completion of the process.

According to an instruction from the control section 111, the conversion section 113 converts inputted processing target data by using codes for non-display characters which are defined in the code storage section 115, and outputs post-conversion data in which a post-conversion character string is embedded. The codes for the non-display characters are character codes to which no character is allocated.

According to an instruction from the control section 111, the inverse conversion section 114 inversely converts a character string represented by using the codes for the non-display characters which are defined in the code storage section 115, among character strings included in inputted processing target data, and outputs post-inverse conversion data including information data restored by the inverse conversion.

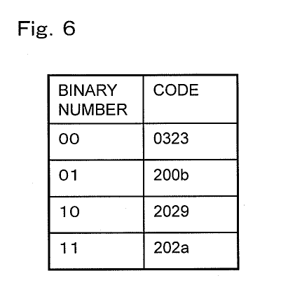

The code storage section 115 has stored therein a conversion rule that uses codes for characters that are not displayed on the screen of the display device 45 (for non-display characters). For example, the code storage section 115 has stored therein, as the conversion rule, a code conversion table in which codes for non-display characters and binary number strings correspond to each other in a one-to-one relation (see FIG. 6).

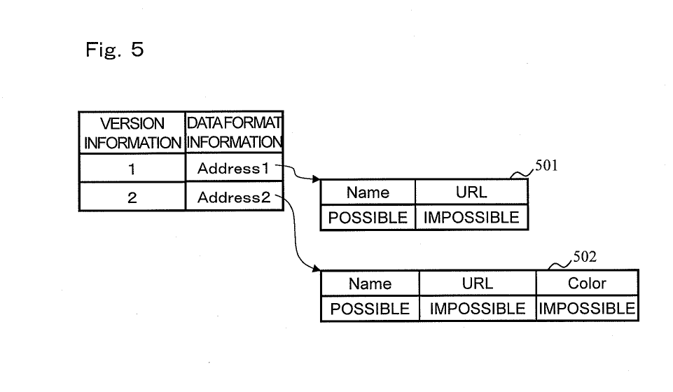

The version information storage section 112 stores therein data format information indicating the structure (data format) of the target data which is utilized by the target program of the information apparatus A100 (self-apparatus). As an example, the version information storage section 112 stores therein column format information of each version of bookmark information that is target data (see FIG. 5). The column format information includes the data formats (the first data format and the second data format) of the input version and the output version among the target data used by the target program, but may include the data formats of all versions.

Hereinafter, with regard to the conversion to a data format of a different version, an example of a process of the information apparatus A100 in the case where an information storing area included only in the first data format among the first data format and the second data format is present as a difference area, will be described with specific target data. The information apparatus A100 is provided with version 2 of the web browser application and uses version 2 of bookmark information. The information apparatus B200 is provided with version 1 of the web browser application and uses version 1 of bookmark information.

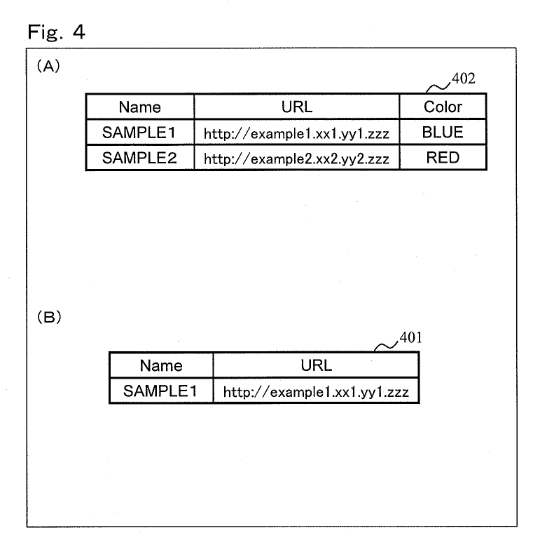

FIG. 4 is an example of target data stored by the data storage section 104 of the information apparatus A100 and the data storage section 204 of the information apparatus B200. FIG. 4(A) shows version 2 of bookmark information 402 stored by the data storage section 104 of the information apparatus A100. FIG. 4(B) shows version 1 of bookmark information 401 stored by the data storage section 204 of the information apparatus B200. In the present embodiment, with regard to the bookmark information, version 1 includes two columns of “Name” and “URL”, and version 2 includes three columns additionally including “Color”. Each of the columns of “Name” and “URL” corresponds to the above common area, and the column of “Color” corresponds to the above difference area. In each row in FIG. 4, information indicating the color of a character to be displayed on the screen is stored in the column of “Color”.

FIG. 5 is an example of data format information stored by the version information storage section 112. FIG. 5 shows an example in which version information corresponds to an address number of a memory area in which data format information is stored. In a memory area corresponding to an address number (Address 1), data format information 501 of version 1 of bookmark information is stored, and in a memory area corresponding to an address number (Address 2), data format information 502 of version 2 of bookmark information is stored.

It is noted that the version information storage section 112 may store therein version information and data format information such that they directly correspond to each other, without using any address number. In the present embodiment, the data format information 501 includes two columns of “Name” and “URL”, and the data format information 502 includes three columns additionally including “Color”. The data format information 501 and 502 retains, for each column, embeddability information indicating whether it is possible to embed a post-conversion character string using the non-display characters, in data. In FIG. 5, for the “Name” column, it is possible to embed a post-conversion character string using the codes for the non-display characters. A column for which it is possible to embed a post-conversion character string using the codes for the non-display characters is, for example, such a column that data in this column is used only for screen display of the information apparatus and is not used for other control. In other words, the column is an information storing area that is used only for generating information of an image based on processing target data in a target program that generates, on the basis of target data, an image to be displayed on a screen. The column is, for example, an information storing area in which a character code obtained by coding character information that is only used to be displayed on a screen is stored.

FIG. 6 is an example of the conversion rule stored by the code storage section 115. FIG. 6 shows a code conversion table (conversion rule) in which codes for characters that are not outputted to the screen of the display device 45 (for non-display characters) and binary number strings correspond to each other in a one-to-one relation. Each code shown in FIG. 6 is a code in Unicode as an example of the standard for the character codes used by the information apparatus A100 and the information apparatus B200. In Unicode, no character is allocated to character codes 0x0323, 0x200b, 0x2029, and 0x202a. Thus, no character is acquired from these four character codes, and characters corresponding to the character codes are not displayed on the screen. It is noted that the codes for the non-display characters may include a code for a space, but desirably does not include a code for a space. In other words, it is desirable to use codes for characters to which nothing is allocated in the standard for the character codes.

It is noted that in the code conversion table of FIG. 6, the code for each non-display character in Unicode is represented by a hexadecimal number. In addition, in the code conversion table, non-display characters other than those of the four codes shown in FIG. 6 may be used. It is noted that the codes for the non-display characters which are not displayed on the screen are different depending on the system specifications and setting of the information apparatus (i.e., depending on the character code standard used by the information apparatus). For example, in ShiftJIS code, character codes 0x8540, 0x8541, 0x8542, and 0x8544 correspond to the codes for the non-display characters. For example, in EUC code, character codes 0x8ff5, 0x8ff6 and 0x8ff8 correspond to the codes for the non-display characters. It is noted that in the present embodiment, the four non-display characters to which no character is allocated in the standard for the character codes are used for the conversion rule, but a code for a character that is not used for screen display in the system may be used for the conversion rule. Thus, in accordance with the configuration and setting of the system, it is possible to select a code for a non-display character to be used for the conversion rule.

It is noted that the components other than the data conversion device 110 does not incorporate the codes for the non-display characters which are defined in the code conversion table, into data to be stored in the column that is set as being embeddable in the version information storage section 112.

It is noted that in the present embodiment, the version of the target program installed in the information apparatus and the version of the target data used by the target program are the same, but the version numbers of the target program and the target data may be different from each other. The version information storage section 112 stores therein the version of the target data and data format information corresponding to the version, such that they correspond to each other.

Due to the above, as shown in FIG. 7 described later, the processing section 102 of the information apparatus A100 that includes the data conversion device 110 according to the aspect of the present invention reads target data from the data storage section 104 through the DBMS 103, and instructs the data conversion device 110 to perform the data conversion process. The data conversion device 110 compares the input version and the output version to each other, and performs the conversion process or the inverse conversion process using the codes for the non-display characters. The processing section 102 transmits post-process data through the communication section 101 to an information apparatus that is a communication partner. In addition, as shown in FIG. 12 described later, the processing section 102 of the information apparatus A100 that includes the data conversion device 110 according to the aspect of the present invention receives target data through the communication section 101 from the information apparatus that is the communication partner, and instructs the data conversion device 110 to perform the data conversion process. The data conversion device 110 compares the input version and the output version to each other, and performs the conversion process or the inverse conversion process using the codes for the non-display characters. The processing section 102 writes post-process data into the data storage section 104 through the DBMS 103. Thus, in the conversion to a data format of a different version, a post-conversion character string to which information data in a difference area determined based on a difference in data format is converted is embedded in the post-conversion data. Then, in returning the data format to the original version, the post-conversion character string is inversely converted, thereby allowing the original information data to be restored.

[Data-Sharing Process in which Information Apparatus a Transmits Target Data to Information Apparatus B]

FIG. 7 is a sequence diagram showing an example of a data-sharing process in which the information apparatus A100 that includes the data conversion device 110 according to the present embodiment transmits target data to another information apparatus. Flow of the data-sharing process in which the information apparatus B200 acquires the target data of the information apparatus A100 will be described with reference to FIG. 7. It is noted that, for example, the information apparatus A100 has programs that cause a computer to perform the data-sharing process and include a program for the data conversion process, and the information apparatus B200 has programs that cause a computer to perform the data-sharing process and do not include a program for the data conversion process. The process described below is a process that is performed in each of the information apparatus A100 and the information apparatus B200 according to the programs included in each of the information apparatus A100 itself and the information apparatus B200 itself. This point is also the same in a data-sharing process in FIG. 12 described later.

The processing section 202 of the information apparatus B200 acquires the version of the bookmark information used by the web browser application (target program) of the information apparatus B200 itself (S321). In this example, the version of the bookmark information of the information apparatus B200 is “1”. It is noted that the processing section 202 may previously store therein the version information of the information apparatus B200 itself. In addition, the processing section 202 may confirm property information of the target program or the target data stored in the data storage section 204 and may acquire the version of the bookmark information.

Next, the processing section 202 of the information apparatus B200 transmits a data acquisition request through the communication section 201 to the information apparatus A100 (S322). In this example, the processing section 202 transmits, to the information apparatus A100, a data acquisition request that requests to acquire the bookmark information included in the information apparatus A100. Request data (the data acquisition request) includes the version acquired in S321, as version information in a payload.

The information apparatus B200 that has transmitted the request data (data acquisition request) waits for a response from the information apparatus A100 for a given time period. When the information apparatus B200 has not received a response from the information apparatus A100 even if the given time period elapses (when the given time period elapses in S323), the information apparatus B200 determines that the data acquisition has failed, and ends the process. It is noted that the processing section 202 of the information apparatus B200 may notify the user of the failure of the data acquisition by means of screen display or sound output.

The processing section 102 of the information apparatus A100 receives the request data (data acquisition request) transmitted in S322, through the communication section 101 (S311).

The processing section 102 of the information apparatus A100 acquires request target data requested by the data acquisition request, from the data storage section 104 (S312). In this example, on the basis of the received data acquisition request, the processing section 102 determines that the bookmark information (target data) is requested, and reads the bookmark information stored in the data storage section 104, through the DBMS 103.

Next, the processing section 102 of the information apparatus A100 acquires the version of the bookmark information used by the web browser application (target program) of the information apparatus A100 itself (S313). In this example, the version of the bookmark information of the information apparatus A100 is “2”. It is noted that the processing section 102 may previously store therein the version information of the information apparatus A100 itself. In addition, the processing section 102 may confirm property information of the target program or the target data acquired from the data storage section 104 in S312 and may acquire the version of the bookmark information. Alternatively, the processes in S312 and S313 may be performed by the data conversion device 110 that has received an instruction for the data conversion process from the processing section 102.

The processing section 102 of the information apparatus A100 instructs the data conversion device 110 to perform the data conversion process (S314). The processing section 102 notifies the data conversion device 110 that the version (the version of the information apparatus A100 itself) acquired in S313 is set as an input version and the version included in the request data (data acquisition request) received in S311 is set as an output version.

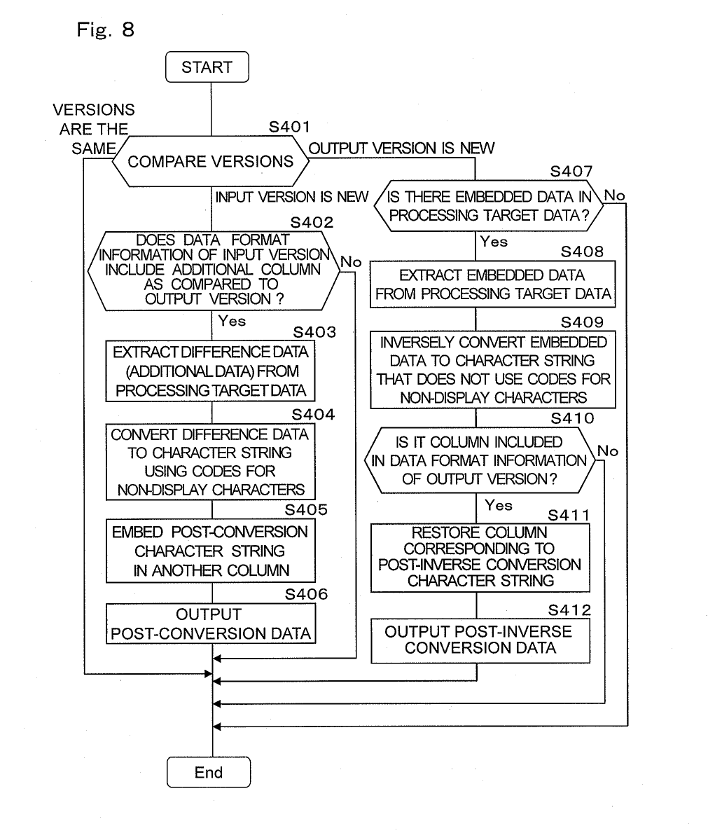

The data conversion device 110 receives the instruction from the processing section 102 and performs a data conversion process of converting the processing target data acquired from the data storage section 104 in S312 to a data format of a different version (S315). The data conversion device 110 compares the input version (version 2) and the output version (version 1) to each other. Since the input version is newer than the output version, the data conversion device 110 instructs the conversion section 113 to perform the conversion process. It is noted that if the output version is newer than the input version, the data conversion device 110 instructs the inverse conversion section 114 to perform the inverse conversion process. The details of the process of the data conversion device 110 will be described later with reference to FIG. 8.

The processing section 102 of the information apparatus A100 acquires post-process data that has been subjected to the data conversion process by the data conversion device 110 (S316). In this example, since the input version is newer than the output version, the processing section 102 acquires post-conversion data that has been subjected to the conversion process.

The processing section 102 of the information apparatus A100 transmits the post-process data acquired in S316, through the communication section 101 to the information apparatus B200 (S317). In this example, the processing section 102 transmits, to the information apparatus B200, post-conversion data obtained by performing the conversion process on the bookmark information of the information apparatus A100. Response data includes the post-conversion data (bookmark information) in a payload.

The processing section 202 of the information apparatus B200 receives the response data transmitted in S317, through the communication section 201 (S324). The processing section 202 of the information apparatus B200 acquires the post-conversion data (bookmark information) included in the received response data and stores the post-conversion data into the data storage section 204 through the DBMS 203.

Due to the above, the processing section 102 of the information apparatus A100 that includes the data conversion device 110 according to the aspect of the present invention reads the request target data from the data storage section 104 through the DBMS 103, and instructs the data conversion device 110 to perform the data conversion process with the read data as processing target data. The data conversion device 110 performs either the conversion process or the inverse conversion process using the codes for the non-display characters, on the basis of the result of the comparison between the input version and the output version, and outputs the post-process data to the processing section 102. The processing section 102 transmits the post-process data through the communication section 101 to the information apparatus B200 that is the communication partner. Thus, in the conversion to a data format of a different version, information data in a difference area determined based on a difference in data format is allowed to be notified to another apparatus in a state where the information data is embedded in post-conversion data. In addition, since the post-conversion data has been subjected to the conversion using the codes for the non-display characters, the user of the other apparatus that has received the post-conversion data does not recognize a character string embedded in the post-conversion data, and the target program is allowed to cause the computer to perform a process utilizing the post-conversion data without specially changing the post-conversion data.

[Detailed Description of Data Conversion Process]

FIG. 8 is a flowchart showing an example of the data conversion process performed by the data conversion device 110 according to the present embodiment. FIG. 8 is a flowchart showing in detail the data conversion process in S315 in FIG. 7.

The control section 111 of the data conversion device 110 receives the processing target data (the target data read from the data storage section 104), information of the input version, and information of the output version, and starts the data conversion process.

The control section 111 compares the received input version and output version to each other (S401). When the input version and the output version are the same in S401, the control section 111 determines that version conversion of data is unnecessary, and ends the data conversion process without performing version conversion of the received processing target data. It is noted that only when the input version and the output version are different from each other, the processing section 102 of the information apparatus A100 may instruct the data conversion device 110 to perform the data conversion process.

When the input version is newer than the output version in S401, the control section 111 causes the conversion section 113 to perform the conversion process through a procedure of S402 to S406. On the other hand, when the output version is newer than the input version in S401, the control section 111 causes the inverse conversion section 114 to perform the inverse conversion process through a procedure of S407 to S411.

[Case of Conversion Process]

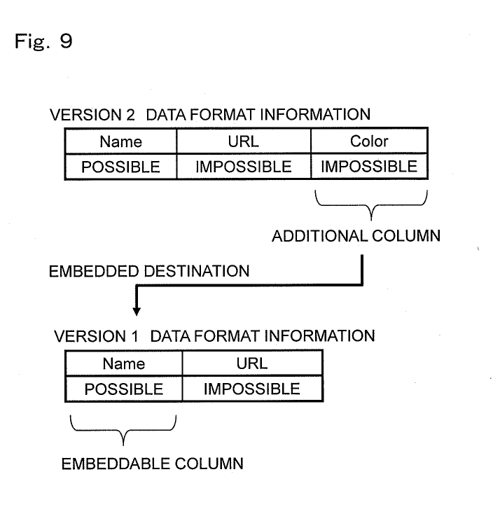

First, the case where the input version is newer than the output version will be described. The control section 111 compares the data format information of the input version stored in the version information storage section 112 to the data format information of the output version. When the first data format corresponding to the input version includes an additional column as compared to the second data format corresponding to the output version (i.e., there is an information storing area included only in the first data format among the first data format and the second data format (a difference area)) (Yes in S402), the control section 111 extracts difference data (additional data) in the difference area from the processing target data (S403). The difference data is data in the additional column in the data format information of the input version. In this example, the “Color” column is the additional column, and data in the “Color” column (specifically, the name of and stored information in the additional column) is the difference data (see FIG. 9). In addition, when there is no additional column in S402, the control section 111 determines that version conversion of data is unnecessary, and ends the process without changing the received processing target data.

The control section 111 notifies the conversion section 113 of the difference data extracted in S403, and instructs the conversion section 113 to perform the conversion process. According to the instruction from the control section 111, the conversion section 113 converts the inputted difference data by using the codes for the non-display characters which are defined in the code storage section 115, to generate a post-conversion character string (S404).

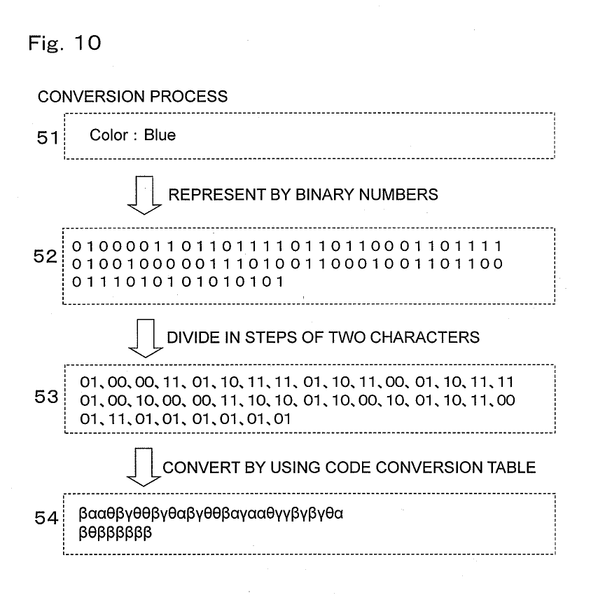

FIG. 10 shows an example of a procedure for the conversion process by the conversion section 113 using the code conversion table in FIG. 6.

First, the conversion section 113 converts difference data 51 which is notified by the control section 111 and is a conversion target, to a number sequence 52 represented by binary numbers. Next, the conversion section 113 divides the number sequence 52 represented by binary numbers through the conversion, in groups of two digits to generate a number sequence 53 in which the numbers are divided in groups of two digits. The conversion section 113 sequentially converts the numbers of each two-digit included in the number sequence 53 to a character string including only a code for a non-display character, by using the code conversion table stored by the code storage section 115, thereby generating a post-conversion character string 54. It is noted that in FIG. 10, the non-display character code 0x0323 in FIG. 6 is represented by “α”, the non-display character code 0x200b is represented by “β”, the non-display character code 0x2029 is represented by “γ”, and the non-display character code 0x202a is represented by “θ”. The reason why each non-display character code is represented in a simplified manner in FIG. 10 is the reason of convenience. The post-conversion character string 54 is actually composed of only the non-display character codes 0x0323, 0x200b, 0x2029, and 0x202a.

With that, the code conversion process by the conversion section 113 in the conversion process is completed. The conversion section 113 subsequently performs a code embedding process.

It is noted that in this example, the four non-display characters are set as non-display characters used for the code conversion table, and thus the number sequence represented by binary numbers through the conversion in S51 is divided in groups of two digits. When five or more non-display characters are used, it is necessary to change the setting for the division. For example, when eight codes for non-display characters are used, the number sequence represented by binary numbers through the conversion in S51 is divided in groups of three digits.

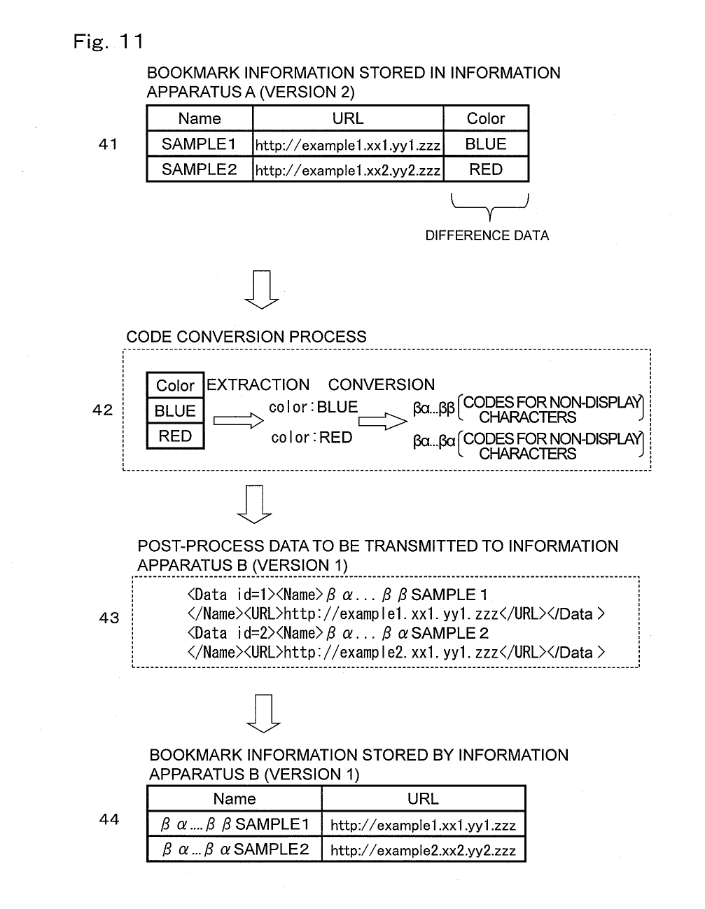

In the code embedding process, the conversion section 113 deletes the difference area (the “Color” column) from the processing target data to generate intermediate data in which the processing target data is converted to the second data format. In the intermediate data, the information data stored in the above common areas among the processing target data is kept from the processing target data. Then, the conversion section 113 embeds the post-conversion character string in a column that is set as being embeddable in the data format information of the output version among the intermediate data (S405). In this example, the “Name” column is the embeddable column (see FIG. 9). The conversion section 113 embeds the post-conversion character string at a position in front of data stored originally in the “Name” column (see FIG. 11). It is noted that the conversion section 113 may embed the post-conversion character string at a position in rear of the data stored originally in the “Name” column. In the present embodiment, the conversion section 113 embeds the post-conversion character string in the intermediate data obtained by deleting the difference area from the processing target data, but may delete the difference area after embedding the post-conversion character string in the processing target data.

At the end, the control section 111 outputs, to the processing section 102, the post-conversion data in which the post-conversion character string is embedded in another column, and completes the data conversion process (S406). In this example, the conversion process is performed on version 2 of the processing target data, and version 1 of the post-conversion data in which the information data in the difference area (Color column) determined based on the difference in data format is embedded in another column (Name column) is outputted.

[Case of Inverse Conversion Process]

Next, the case where the output version is newer than the input version will be described. The control section 111 determines whether embedded data corresponding to a post-conversion character string using the codes for the non-display characters is embedded in the processing target data (S407). When embedded data is embedded, the processing target data is post-conversion data that has been subjected to the conversion process by using the codes for the non-display characters. When embedded data is embedded in the processing target data (Yes in S407), the control section 111 extracts the embedded data from the processing target data (S408). On the other hand, when embedded data is not embedded in the processing target data (No in S407), the control section 111 determines that the process is unnecessary, and ends the data conversion process without changing the received processing target data.

The control section 111 notifies the inverse conversion section 114 of the embedded data extracted in S408, and instructs the inverse conversion section 114 to perform the inverse conversion process. According to the instruction from the control section 111, the inverse conversion section 114 inversely converts the inputted embedded data by using the codes for the non-display characters which are defined in the code storage section 115, and outputs a post-inverse conversion character string (S409).

The control section 111 receives the post-inverse conversion character string outputted by the inverse conversion section 114 and determines whether the column corresponding to the post-inverse conversion character string is a column included in the data format information of the output version (i.e., an information storing area included only in the second data format among the first data format and the second data format (a difference area)) (S410). When it is a column included in the data format information of the output version (Yes in S410), the control section 111 instructs the inverse conversion section 114 to perform a restoration process. The inverse conversion section 114 restores the column corresponding to the post-inverse conversion character string by performing a process whose procedure is inversed to that in FIG. 10 (S411). In other words, the column corresponding to the post-inverse conversion character string and the information data in the column are added to the processing target data. On the other hand, when it is not a column included in the data format information of the output version (No in S410), the control section 111 determines that the process of restoring the information data in the column from the post-inverse conversion character string is not necessary, and ends the data conversion process without changing the received processing target data.

At the end, the control section 111 outputs, to the processing section 102, the post-inverse conversion data in which the column corresponding to the post-inverse conversion character string is restored, and completes the data conversion process (S412).

[Change of Target Data in Data Conversion Process]

FIG. 11 specifically shows an example of change of data when the information apparatus that includes the data conversion device 110 according to the present embodiment transmits post-conversion data to another information apparatus. First, the data storage section 104 of the information apparatus A100 has stored therein bookmark information 41 that is target data. The data conversion process is performed with this bookmark information as processing target data.

The data conversion device 110 of the information apparatus A100 extracts information data (difference data) in a difference area from the processing target data 41, and performs a code conversion process 42. In this example, data corresponding to the Color column in the bookmark information is the difference data and becomes a target of the code conversion process. In the code conversion process 42, the data conversion device 110 of the information apparatus A100 extracts information data in each row of database from the extracted difference data, and converts the extracted information data by using the codes for the non-display characters. Next, the processing section 102 of the information apparatus A100 receives, from the data conversion device 110, post-process data 43 (post-conversion data) in which a post-conversion character string is embedded, and transmits the post-process data 43 through the communication section 101 to the information apparatus B200. Next, the processing section 202 of the information apparatus B200 receives the post-process data from the information apparatus A100 and stores the post-process data into the data storage section 204. Reference numeral 44 is bookmark information stored by the information apparatus B200 into the data storage section 204.

It is noted that in FIG. 11, the non-display character code 0x0323 in FIG. 6 is represented by “α”, the non-display character code 0x200b in FIG. 6 is represented by “β”, the non-display character code 0x2029 in FIG. 6 is represented by “γ”, and the non-display character code 0x202a in FIG. 6 is represented by “θ”. The reason why each non-display character code is represented in a simplified manner in FIG. 11 is the reason of convenience. In the actual post-process data, the post-conversion character string is composed of only the non-display character codes 0x0323, 0x200b, 0x2029, and 0x202a. In the target data stored in the data storage section 204 of the information apparatus B, the information data in the Color column that has been converted to the codes for the non-display characters (α and β in FIG. 11) is embedded in the Name column.

[Data-Sharing Process in which Information Apparatus a Receives Target Data from Information Apparatus B]

FIG. 12 is a sequence diagram showing an example of a data-sharing process in which the information apparatus A that includes the data conversion device 110 according to the present embodiment receives target data from the information apparatus B. Flow of the data-sharing process in which the information apparatus A100 receives the target data of the information apparatus B200 will be described with reference to FIG. 12.

The processing section 102 of the information apparatus A100 acquires the version of the bookmark information used by the web browser application (target program) of the information apparatus A100 itself (S331). In this example, the version of the bookmark information of the information apparatus A100 is “2”. It is noted that the processing section 102 may previously store therein the version information of the information apparatus A100 itself. In addition, the processing section 102 may confirm property information of the target program or the target data stored in the data storage section 104 and may acquire the version of the bookmark information.

Next, the processing section 102 of the information apparatus A100 transmits a data acquisition request through the communication section 101 to the information apparatus B200 (S332). In this example, the processing section 102 transmits, to the information apparatus B200, a data acquisition request that requests to acquire the bookmark information included in the information apparatus B200. Request data (the data acquisition request) includes the version acquired in S331, as version information in a payload. It is noted that the name of the target program may be included in the payload.

The information apparatus A100 that has transmitted the request data (data acquisition request) waits for a response from the information apparatus B200 for a given time period. When the information apparatus A100 has not received a response from the information apparatus B200 even if the given time period elapses (when the given time period elapses in S333), the information apparatus A100 determines that the data acquisition has failed, and ends the process. It is noted that the processing section 102 of the information apparatus A100 may notify the user of the failure of the data acquisition by means of screen display or sound output.

The processing section 202 of the information apparatus B200 receives the request data (data acquisition request) transmitted in S332, through the communication section 201 (S341).

The processing section 202 of the information apparatus B200 acquires target data requested by the data acquisition request, from the data storage section 204 (S342). In this example, on the basis of the received data acquisition request, the processing section 202 determines that the bookmark information (target data) is requested, and reads the bookmark information stored in the data storage section 204, through the DBMS 203.

Next, the processing section 202 of the information apparatus B200 acquires the version of the bookmark information used by the web browser application (target program) of the information apparatus B200 itself (S343). In this example, the version of the bookmark information of the information apparatus B200 is “1”. It is noted that the processing section 202 may previously store therein the version information of the information apparatus B200 itself. In addition, the processing section 202 may confirm property information of the target program or the target data acquired from the data storage section 204 in S342 and may acquire the version of the bookmark information.

The processing section 202 of the information apparatus B200 transmits the target data acquired in S343, through the communication section 201 to the information apparatus A100 (S344). In this example, the processing section 202 transmits, to the information apparatus A100, the bookmark information stored in the data storage section 204 by the information apparatus B200. Response data includes the bookmark information in a payload.

The processing section 102 of the information apparatus A100 receives the response data transmitted in S344, through the communication section 101 (S334). The processing section 102 of the information apparatus A100 acquires the target data (bookmark information) included in the received response data and instructs the data conversion device 110 to perform the data conversion process with the acquired target data as processing target data (S335). The processing section 102 notifies the data conversion device 110 of the input version included in the response data received in S334 and the output version that is the version used by the information apparatus A100 itself.

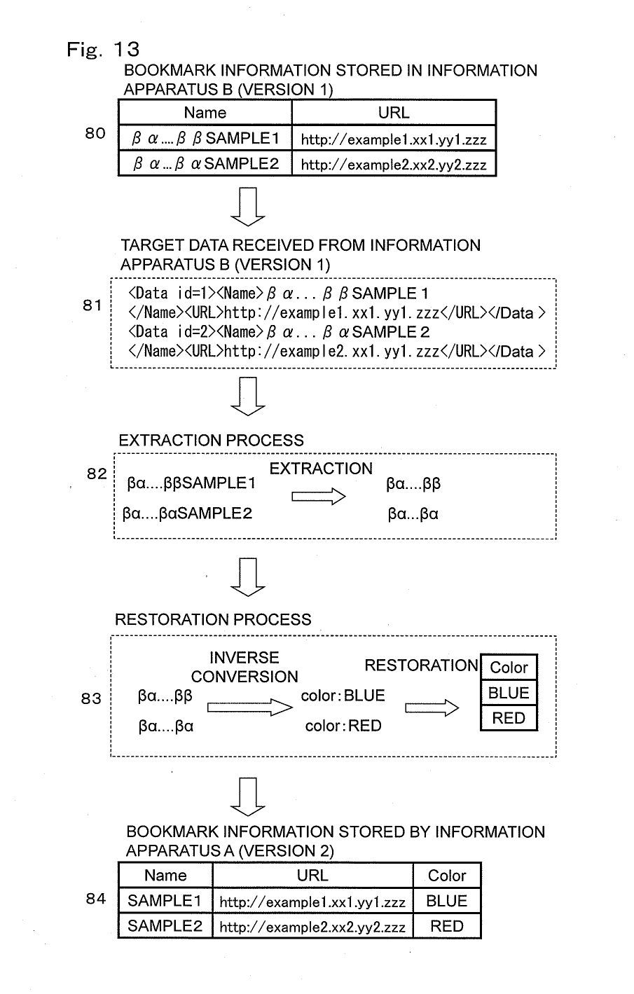

The data conversion device 110 receives the instruction from the processing section 102 and performs a data conversion process of converting the processing target data to a data format of a different version (S336). The data conversion device 110 compares the input version (version 1) and the output version (version 2) to each other. Since the output version is newer than the input version, the data conversion device 110 instructs the inverse conversion section 114 to perform the inverse conversion process. It is noted that if the input version is newer than the output version, the data conversion device 110 instructs the conversion section 113 to perform the conversion process. The details of the process of the data conversion device 110 will be described later with reference to FIG. 13.

The processing section 102 of the information apparatus A100 acquires, from the data conversion device 110, post-process data that has been subjected to the data conversion process (S337). In this example, since the output version is newer than the input version, the processing section 102 acquires post-inverse conversion data.

The processing section 102 of the information apparatus A100 stores the post-process data acquired in S337, into the data storage section 104 through the DBMS 103.

Due to the above, the processing section 102 of the information apparatus A100 that includes the data conversion device 110 according to the aspect of the present invention receives data from another apparatus as a result of making a data acquisition request to the other apparatus, and instructs the data conversion device 110 to perform the data conversion process with the received data as processing target data. The data conversion device 110 performs either the conversion process or the inverse conversion process using the codes for the non-display characters, on the basis of the result of the comparison between the input version and the output version. The processing section 102 stores post-process data into the data storage section 104 through the DBMS 103. Thus, in the inverse conversion to a data format of a different version, the data format of the processing target data in which information data in a difference area determined based on a difference in data format is embedded is inversely converted to the original version, thereby allowing the information data in the difference area to be restored. In addition, since the post-conversion data has been subjected to the conversion using the codes for the non-display characters, the user of the other apparatus that uses the post-conversion data does not recognize the character string embedded in the post-conversion data, and the target program is allowed to cause the computer to perform a process utilizing the post-conversion data without specially changing the post-conversion data.

[Change of Target Data in Inverse Process]

FIG. 13 specifically shows an example of change of data when the information apparatus that includes the data conversion device 110 according to the present embodiment receives post-conversion data from another information apparatus. First, the data storage section 204 of the information apparatus B200 has stored therein bookmark information 80 that is target data. This is the same as the data 44 which is stored by the processing section 202 of the information apparatus B200 into the data storage section 204 in FIG. 11.

The processing section 102 of the information apparatus A100 receives target data 81 as processing target data from the information apparatus B200. Next, the data conversion device 110 of the information apparatus A100 performs an extraction process 82 of extracting embedded data composed of the codes for the non-display characters, from the processing target data. Next, in a restoration process 83, the data conversion device 110 of the information apparatus A100 extracts information data corresponding to each row of database, from the extracted embedded data, and inversely converts the extracted information data using the conversion rule which uses the codes for the non-display characters. Furthermore, the data conversion device 110 of the information apparatus A100 restores the inversely-converted information data from each row as the corresponding column. In this example, data corresponding to a Color column in the bookmark information is restored. Next, the processing section 102 of the information apparatus A100 receives post-process data (post-inverse conversion data) from the data conversion device 110 and stores the post-process data into the data storage section 204. Reference numeral 84 is bookmark information stored by the information apparatus A100 into the data storage section 104.

It is noted that in FIG. 13, the non-display character code 0x0323 in FIG. 6 is represented by “α”, the non-display character code 0x200b in FIG. 6 is represented by “β”, the non-display character code 0x2029 in FIG. 6 is represented by “γ”, and the non-display character code 0x202a in FIG. 6 is represented by “θ”. The reason why each non-display character code is represented in a simplified manner in FIG. 13 is the reason of convenience. The actual embedded data is composed of only the non-display character codes 0x0323, 0x200b, 0x2029, and 0x202a. In the target data stored in the data storage section 204 of the information apparatus B, the information data in the Color column that has been converted to the codes for the non-display characters (α and β in FIG. 13) is embedded in the Name column.

It is noted that the sequences in FIGS. 7 and 12 each show an example in which transmission/reception of data is performed between the information apparatus A100 and the information apparatus B200. Data that is transmitted from the information apparatus A100 to the information apparatus B200 and received by the information apparatus B200 from the information apparatus A100 may be further transmitted to another information apparatus C. It is noted that the information apparatus C needs to store therein a code conversion table that is the same as that of the information apparatus A100.

Due to the above, according to the data conversion device 110 according to the aspect of the present invention, in the conversion to a data format of a different version, the post-conversion character to which the information data in the difference area determined based on the difference in data format is converted is embedded in the post-conversion data. The data conversion device 110 inversely converts the data format of the post-conversion data to the original version, thereby allowing the original information data having been previously present in the difference area to be restored.

In addition, since the conversion has been performed by using the codes for the non-display characters, even when an image based on the post-conversion data is displayed on a screen of another apparatus that has received the post-conversion data, the non-display characters obtained by converting the post-conversion character string in the post-conversion data are not displayed. Therefore, the user is allowed to utilize the post-conversion data without recognizing the post-conversion character string. In addition, the computer that executes the target program is allowed to operate without causing a malfunction due to the post-conversion character string embedded in the post-conversion data.

According to this configuration, in conducting synchronization, migration, or the like of information between two or more apparatuses provided with different versions of a program, for example, even when target data in a database format is used, information in the target data is not lost even if the target data is migrated to an apparatus with another version including less columns. When the information is migrated again to the apparatus with the original version, the original information data before the migration is allowed to be restored and reutilized.

### Embodiment 2

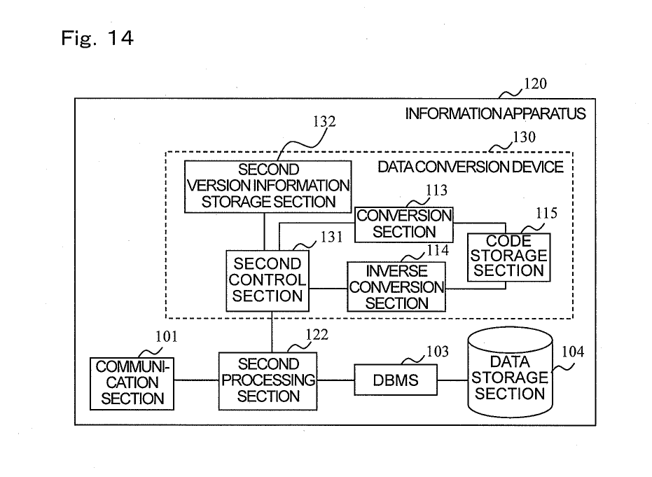

FIG. 14 is a block diagram showing the configuration of an information apparatus that includes a data conversion device 130 according to the present embodiment.

Two information apparatuses (hereinafter, referred to as an information apparatus A and an information apparatus B) each of which includes the data conversion device 130 according to an aspect of the present invention perform transmission/reception of target data therebetween, thereby utilizing the target data of the partner apparatuses. The information apparatus A and the information apparatus B are provided with the same target program (different versions of the same program) and have stored therein target data to be utilized by the target program, in a database format.

The information apparatus A and the information apparatus B perform transmission/reception of the target data, stored in the database format, therebetween to share the target data. The different versions of the target program may be different from each other in used data format (item in the database format for which data is collected (column in the present embodiment)) and may not be able to utilize the same data. Thus, each information apparatus converts received target data to the version of the information apparatus itself and utilizes the resultant data.

The target program is, for example, a web browser application. The target data stored in the database format is bookmark information. It is noted that in the web browser application, the target data to be shared by a plurality of information apparatuses may be other data such as history information. In addition, the target program may be another program such as an e-mail application or a schedule application. In this case, the target data to be shared is other data such as address book data or schedule data.

An information apparatus 120 includes a data conversion device 130, a communication section 101, a second processing section 122, a database management system (hereinafter, referred to as DBMS) 103, and a data storage section 104.

The communication section 101 performs a process of transmitting data and a process of receiving data via a network. The communication section 101 corresponds to the communication device 30 in FIG. 2 and operates according to instructions from a program that runs on the CPU 10.

The data storage section 104 is a memory that stores therein target data in a database format which is utilized by a target program that runs on the information apparatus 120 (self-apparatus). The target data in the database format is data of bookmark information. The data storage section 104 corresponds to the memory device 20 in FIG. 2. It is noted that when the information apparatus 120 is able to utilize an external memory as a storage area for the bookmark information, the portable storage medium 31 may be used as the data storage section 104.

The DBMS 103 accesses the data storage section 104 of the information apparatus 120 itself and controls writing and reading of the target data in the database format and the like.

The second processing section 122 controls a data-sharing process for sharing, with another information apparatus, the target data in the database format which is utilized by the target program of the information apparatus 120 itself. The second processing section 122 corresponds to the CPU 10 which operates according to the program stored in the memory device 20 in FIG. 2. The second processing section 122 reads transmission target data from the data storage section 104 through the DBMS 103 and instructs the data conversion device 130 to perform a data conversion process with the read data as processing target data, in the information apparatus 120 itself. The second processing section 122 transmits post-process data that has been subjected to the data conversion process by the data conversion device 130, through the communication section 101 to an information apparatus that is a communication partner. In addition, the second processing section 122 instructs the data conversion device 130 to perform a data conversion process with, as processing target data, target data received through the communication section 101 from the information apparatus that is the communication partner. Then, the second processing section 122 writes post-process data that has been subjected to the data conversion process by the data conversion device 130, into the data storage section 104 through the DBMS 103.

The data conversion device 130 receives an instruction from the second processing section 122 of the information apparatus 120 itself and performs a conversion process to the data format of the version of the information apparatus 120 itself or an inverse conversion process for restoring the entirety of embedded data. The data conversion device 130 embeds information data in a difference area determined based on a difference in data format, in post-conversion data in the conversion process to the version of the information apparatus 120 itself, thereby allowing the information data to be restored in the inverse conversion process for restoring the difference area.

The data conversion device 130 includes a second control section 131, a second version information storage section 132, a conversion section 113, an inverse conversion section 114, and a code storage section 115.

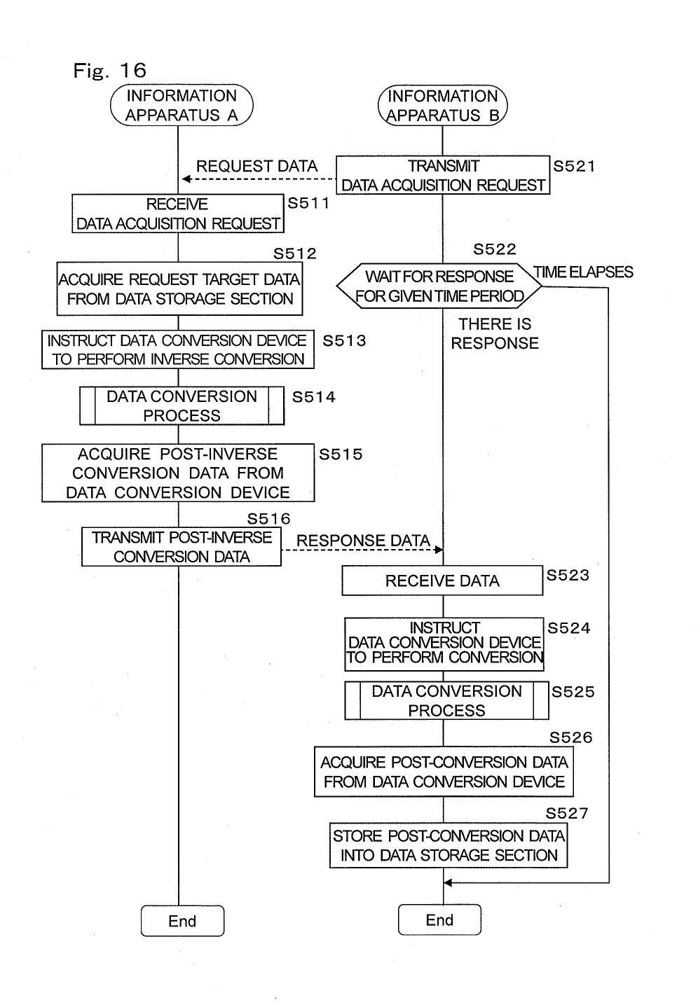

The second control section 131 receives an instruction for the conversion process or an instruction for the inverse conversion process from the second processing section 122 and controls the conversion process to the data format of the version of the information apparatus 120 itself or the inverse conversion process on the entirety of embedded data. The second control section 131 corresponds to the CPU 10 which operates according to the program stored in the memory device 20 in FIG. 2. The second control section 131 receives processing target data from the second processing section 122. When, like an information apparatus A in FIG. 16 described later, the information apparatus transmits target data to another apparatus, the processing target data is data stored in the data storage section 104 of the information apparatus 120 itself. In addition, when, like an information apparatus B in FIG. 16 described later, the information apparatus receives target data from another apparatus, the processing target data is data received from the other apparatus.

For example, when an information storing area included only in a first data format among the first data format corresponding to an input version that is the version of processing target data received from another apparatus and a second data format corresponding to an output version that is the version of the information apparatus 120 itself is present as a difference area, the second control section 131 receives the instruction for the conversion process from the second processing section 122 of the information apparatus 120 itself. When the second control section 131 receives the instruction for the conversion process from the second processing section 122, the second control section 131 compares the data formats of the input version and the output version to each other and performs the conversion process by using the conversion section 113, to generate post-conversion data of the output version (the version of the information apparatus 120 itself). When the data format of the processing target data agrees with the data format of the version of the information apparatus 120 itself, the second control section 131 does not perform the process and notifies the second processing section 122 of completion of the process. On the other hand, for example, when an information storing area included only in the second data format among the first data format corresponding to the input version that is the version of processing target data read from the data storage section 104 of the information apparatus 120 itself and the second data format corresponding to the output version is present as a difference area, the second control section 131 receives the instruction for the inverse conversion process from the second processing section 122 of the information apparatus 120 itself. When the second control section 131 receives the inverse conversion instruction from the second processing section 122, the second control section 131 performs the inverse conversion process on the entirety of embedded data by using the inverse conversion section 114, to generate post-inverse conversion data. When no embedded data is included in the processing target data, the second control section 131 does not perform the inverse conversion process and notifies the second processing section 122 of completion of the process.

According to an instruction from the second control section 131, the conversion section 113 converts inputted processing target data by using codes for non-display characters which are defined in the code storage section 115, to generate a post-conversion character string.

According to an instruction from the second control section 131, the inverse conversion section 114 inversely converts inputted embedded data (a character string represented by using the codes for the non-display characters which are defined in the code storage section 115) and outputs post-inverse conversion data.

The code storage section 115 has stored therein a conversion rule that uses codes for characters that are not displayed on the screen of the display device 45 of the information apparatus (self-apparatus) (for non-display characters). For example, the code storage section 115 has stored therein, as the conversion rule, a code conversion table in which codes for non-display characters and binary number strings correspond to each other in a one-to-one relation.

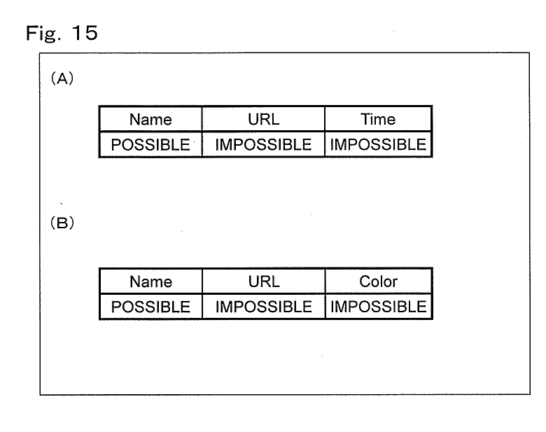

The second version information storage section 132 stores therein data format information indicating the data format of the version of the target data which is utilized by the target program of the information apparatus 120 itself FIG. 15 shows an example of the data format information stored by the second version information storage section 132. FIG. 15(A) shows column format information of version 1 of bookmark information, and FIG. 15(B) shows column format information of version 2 of bookmark information.

In the present embodiment, unlike Embodiment 1, version 1 of the bookmark information includes three columns of “Name”, “URL”, and “Time”. Version 2 of the bookmark information includes three columns of “Name”, “URL”, and “Color”. The data format information retains, for each column, embeddability information indicating whether it is possible to embed a post-conversion character string using the codes for the non-display characters, in data. In FIGS. 15(A) and 15(B), for the “Name” column, it is possible to embed a post-conversion character string using the codes for the non-display characters. A column for which it is possible to embed a post-conversion character string using the codes for the non-display characters is, for example, such a column that data in this column is used only for screen display of the information apparatus and is not used for other control. In other words, the column is an information storing area that is used only for generating an image based on processing target data in a target program that generates, on the basis of target data, an image to be displayed on a screen.

Due to the above, the second processing section 122 of the information apparatus that includes the data conversion device 130 according to the aspect of the present invention instructs the data conversion device 130 to perform the inverse conversion process with, as processing target data, data read from the data storage section 104 through the DBMS 103. The data conversion device 130 performs the inverse conversion process for restoring the entirety of embedded data, to generate post-inverse conversion data. The second processing section 122 transmits the post-inverse conversion data through the communication section 101 to an information apparatus that is a communication partner. In addition, the second processing section 122 of the information apparatus that includes the data conversion device 130 according to the aspect of the present invention instructs the data conversion device 130 to perform the conversion process with, as processing target data, data received through the communication section 101 from the information apparatus that is the communication partner. The data conversion device 130 performs the conversion process to the version of the information apparatus 120 itself. The second processing section 122 writes post-conversion data into the data storage section 104 through the DBMS 103. Thus, in the conversion to a data format of a different version, a post-conversion character string to which information data in a difference area determined based on a difference in data format is converted is embedded in the post-conversion data. Then, in returning the data format to the original version, the post-conversion character string is inversely converted, thereby allowing the original information to be restored.

In addition, even when transmission/reception of target data is performed between three or more information apparatuses, each information apparatus does not need to store therein a code conversion table that is the same as that of another information apparatus, and a procedure such as previously performing setting for sharing is unnecessary.

FIG. 16 is a sequence diagram showing an example of a data-sharing process in which the information apparatus that includes the data conversion device 130 according to the present embodiment performs transmission/reception of data with another information apparatus. Flow of the data-sharing process in which the information apparatus B acquires target data of the information apparatus A will be described with reference to FIG. 16.

Here, the target program installed in the information apparatus A uses version 2 of bookmark information (see FIG. 15(B)) as target data. The target program installed in the information apparatus B uses version 1 of bookmark information (see FIG. 15(A)) as target data. In upgrading the target program from version 1 to version 2, the column of “Time” is deleted from the data format of the target data, and the column of “Color” is added. It is noted that, for example, information stored in the column of “Time” represents the date and time at which the bookmark information is acquired.

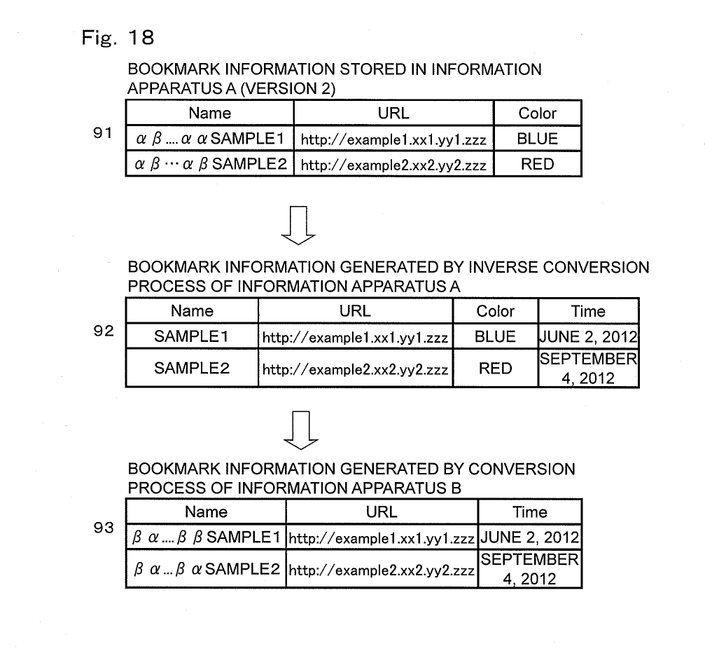

In the data storage section 104 of the information apparatus A, target data that has been acquired from the information apparatus B and then previously subjected to a conversion process by the information apparatus A itself is stored. In this conversion process, with the column of “Time” as a difference area, information data in the column of “Time” is converted into a post-conversion character string using the codes for the non-display characters, and the post-conversion character string is embedded in the column of “Name”. In other words, in the data storage section 104, as shown in FIG. 18, target data 91 is stored in which the post-conversion character string to which the information data in the column of “Time” is converted by using the codes for the non-display characters is embedded in the column of “Name”.

The second processing section 122 of the information apparatus B transmits a data acquisition request through the communication section 101 to the information apparatus A (S521). In this example, the second processing section 122 transmits, to the information apparatus A, a data acquisition request that requests to acquire the bookmark information included in the information apparatus A.

The information apparatus B that has transmitted request data (the data acquisition request) waits for a response from the information apparatus A for a given time period. When the information apparatus B has not received a response from the information apparatus A100 (when the given time period elapses in S522), the information apparatus B determines that the data acquisition has failed, and ends the process. It is noted that the second processing section 122 of the information apparatus B may notify the user of the failure of the data acquisition by means of screen display or sound output.

The second processing section 122 of the information apparatus A receives the request data (data acquisition request) transmitted in S521, through the communication section 101 (S511). The second processing section 122 of the information apparatus A acquires request target data requested by the data acquisition request, from the data storage section 104 (S512). In this example, on the basis of the received data acquisition request, the second processing section 122 of the information apparatus A determines that the bookmark information (target data) is requested, and reads the bookmark information 91 stored in the data storage section 104, through the DBMS 103.

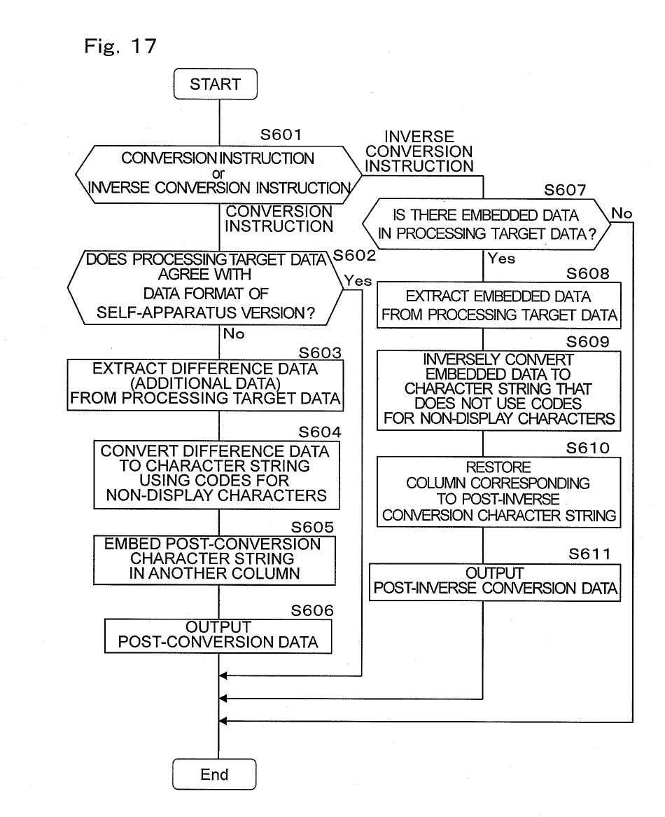

The second processing section 122 of the information apparatus A instructs the data conversion device 130 to perform an inverse conversion process (S513). The second processing section 122 notifies the data conversion device 130 of the target data acquired in S512, as processing target data. The data conversion device 130 receives the instruction for the inverse conversion process from the second processing section 122 and performs the inverse conversion process on the processing target data (S514). In the inverse conversion process, with the column of “Name” as a difference area, embedded data embedded in the column of “Name” is extracted, and post-inverse conversion data is generated in which the column of “Time” is restored from the embedded data. Through the inverse conversion process, bookmark information 92 (see FIG. 18) including four columns of “Name”, “URL”, “Color”, and “Time” is generated as the post-inverse conversion data. The details of the process of the data conversion device 130 will be described later with reference to FIG. 17.

The second processing section 122 of the information apparatus A acquires the post-inverse conversion data that has been subjected to the inverse conversion process by the data conversion device 130 (S515). The second processing section 122 of the information apparatus A transmits the post-inverse conversion data acquired in S515, through the communication section 101 to the information apparatus B (S516). In this example, the second processing section 122 transmits the bookmark information 92 (post-inverse conversion data) to the information apparatus B. Response data includes the bookmark information 92 (post-inverse conversion data) in a payload.

The second processing section 122 of the information apparatus B receives the response data transmitted in S516, through the communication section 101 (S523). The second processing section 122 of the information apparatus B acquires the target data (bookmark information 92) included in the received response data and instructs the data conversion device 130 to perform a conversion process with the acquired target data as processing target data (S524). The second processing section 122 notifies the data conversion device 130 of the processing target data included in the response data.

The data conversion device 130 of the information apparatus B receives the instruction for the conversion process from the second processing section 122 and performs the conversion process of converting the processing target data to the version of the information apparatus B itself (S525). In the conversion process, with the column of “Color” as a difference area, information data in the column of “Color” is converted into a post-conversion character string using the codes for the non-display characters, and post-conversion data is generated in which the post-conversion character string is embedded in the column of “Name”. Through the conversion process, the information apparatus B version of bookmark information 93 is generated as the post-conversion data. As shown in FIG. 18, the bookmark information 93 includes three columns of “Name”, “URL”, and “Time”. The details of the process of the data conversion device 130 will be described later with reference to FIG. 17.

The second processing section 122 of the information apparatus B acquires the post-conversion data that has been subjected to the conversion process by the data conversion device 130 (S526). The second processing section 122 of the information apparatus B stores the post-conversion data acquired in S526, into the data storage section 104 through the DBMS 103.

FIG. 17 is a flowchart showing an example when the data conversion device 130 according to the present embodiment performs the conversion process and the inverse conversion process on data. FIG. 17 is a flowchart showing in detail the processes in S514 and S525 in FIG. 16.

The second control section 131 of the data conversion device 130 receives processing target data and starts the process. The second control section 131 determines whether a received instruction is an instruction for the conversion process or an instruction for the inverse conversion process (S601).

When the second control section 131 determines in S601 that it is an instruction for the conversion process, the second control section 131 causes the conversion section 113 to perform the conversion process through a procedure of S602 to S606. On the other hand, the second control section 131 determines in S601 that it is an instruction for the inverse conversion process, the second control section 131 causes the inverse conversion section 114 to perform the inverse conversion process through a procedure of S607 to S611.

First, the case of the conversion process will be described.

The second control section 131 determines whether data format information of an input version that is the version of the processing target data agrees with data format information of an output version that is the self-apparatus version stored in the second version information storage section 132 (S602). When the data format information of the input version does not agree with the data format information of the output version (No in S602), the second control section 131 extracts difference data (additional data) from the processing target data (S603). The difference data is data in a column that is included in the data format information of the input version and not included in the data format information of the output version. On the other hand, when the data format information of the input version agrees with the data format information of the output version in S602 (Yes in S602), the second control section 131 determines that version conversion of data is unnecessary, and ends the data conversion process without changing the received processing target data.

The second control section 131 notifies the conversion section 113 of the difference data extracted in S603 and instructs the conversion section 113 to perform conversion. According to the instruction from the second control section 131, the conversion section 113 converts the inputted difference data by using the codes for the non-display characters which are defined in the code storage section 115, to generate a post-conversion character string (S604).

Furthermore, the conversion section 113 embeds the post-conversion character string in a column that is set as being embeddable in the data format information of the output version (S605). At the end, the second control section 131 outputs, to the second processing section 122, post-conversion data in which the post-conversion character string is embedded in another column, and completes the process (S606).

A case where this conversion process is applied to the information apparatus B in FIG. 16 will be described. In the information apparatus B, the second control section 131 that has received the instruction for the conversion process from the second processing section 122 determines in S602 that the data format information of the input version does not agree with the data format information of the output version (information apparatus B itself version) stored in the second version information storage section 132, and extracts information data in the column of “Color” (the column name and stored information) as difference data from the processing target data in S603. The conversion section 113 of the information apparatus B generates, in S604, a post-conversion character string to which the difference data extracted in S603 is converted by using the code conversion table stored in the code storage section 115, and generates, in S605, post-conversion data in which the post-conversion character string is embedded in the column of “Name”. In S606, the conversion section 113 outputs the post-conversion data generated in S605.

Next, the case of the inverse conversion process will be described.

The second control section 131 determines whether embedded data corresponding to a post-conversion character string using the codes for the non-display characters is embedded in the processing target data (S607). When embedded data is embedded, the processing target data is post-conversion data that has been subjected to the conversion process by using the codes for the non-display characters. When embedded data is embedded in the processing target data (Yes in S607), the second control section 131 extracts the embedded data from the processing target data (S608). On the other hand, when embedded data is not embedded in the processing target data (No in S607), the second control section 131 determines that the inverse conversion process is unnecessary, and ends the process without changing the received processing target data.

The second control section 131 notifies the inverse conversion section 114 of the post-conversion character string (embedded data) extracted in S608 and instructs the inverse conversion section 114 to perform the inverse conversion process. According to the instruction from the second control section 131, the inverse conversion section 114 inversely converts the inputted post-conversion character string by using the codes for the non-display characters which are defined in the code storage section 115, and outputs a post-inverse conversion character string (S609). Furthermore, the inverse conversion section 114 restores the column corresponding to the post-inverse conversion character string (S610).

At the end, the second control section 131 outputs post-inverse conversion data in which the column corresponding to the post-inverse conversion character string is restored, and completes the process (S611).

A case where this inverse conversion process is applied to the information apparatus A in FIG. 16 will be described. In the information apparatus A, the second control section 131 that has received the instruction for the inverse conversion process from the second processing section 122 determines in S607 that embedded data is embedded in the processing target data, and extracts the embedded data embedded in the column of “Name” in S608. In S609, the inverse conversion section 114 generates a post-inverse conversion character string to which the embedded data extracted in S608 is inversely converted by using the code conversion table stored in the code storage section 115. Then, in S610, the inverse conversion section 114 generates post-inverse conversion data in which the column of “Time” is restored from the post-inverse conversion character string. In S611, the inverse conversion section 114 outputs the post-inverse conversion data generated in S610.

It is noted that in the case where, as in Embodiment 1, version 1 of bookmark information does not include a column that is not included in version 2 of bookmark information, the information apparatus A does not perform the conversion process when acquiring the bookmark information of the information apparatus B. Thus, even when the data acquisition request is received from the information apparatus B in S511, the inverse conversion process is not performed.

Due to the above, according to the data conversion device 130 according to the aspect of the present invention, in the conversion to a data format of a different version, the post-conversion character string to which information in the difference area determined based on the difference in data format is converted is embedded in post-conversion data. The data conversion device 130 inversely converts the data format of the post-conversion data to the original version, thereby allowing the original information having been previously present in the difference area to be restored.

In addition, when the post-conversion data is used, since the post-conversion data has been subjected to the conversion by using the codes for the non-display characters, even if an image based on the post-conversion data is displayed on the screen, the non-display characters obtained by converting a post-conversion character string in the post-conversion data are not displayed. Therefore, the user is allowed to utilize the post-conversion data without recognizing the post-conversion character string. Moreover, the computer that executes the target program is allowed to operate without causing a malfunction due to the post-conversion character string embedded in the post-conversion data.

Furthermore, according to the data conversion device 130 according to the aspect of the present invention, the information apparatus that performs the conversion process on data and the information apparatus that inversely converts the post-conversion data are always the same. Thus, each of a plurality of information apparatuses does not need to store therein a code conversion table that is the same as that of another information apparatus, and a procedure such as previously performing setting for sharing is unnecessary.

[Other Examples of Target Data]

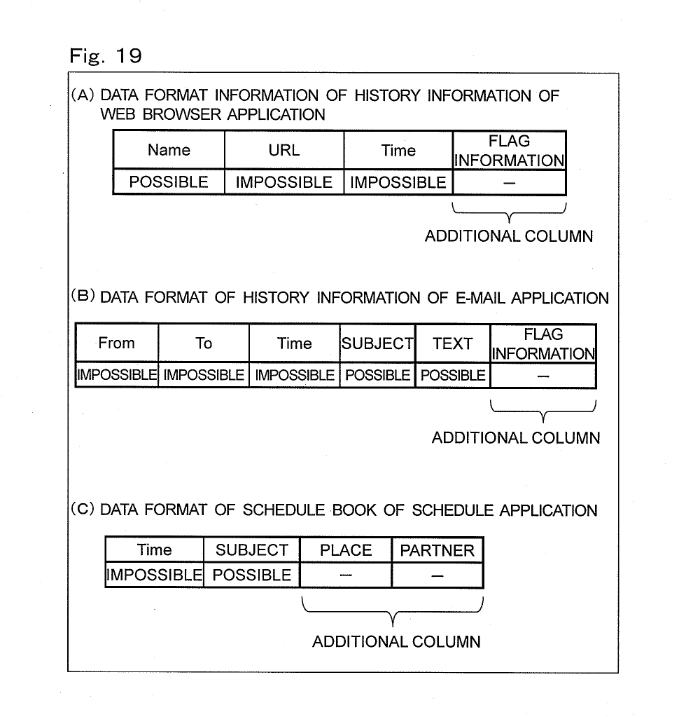

FIG. 19 shows target data other than bookmark information. FIG. 19(A) shows data format information of history information that indicates browsing history of web pages and is used in a web browser application. When history information is set as target data, an old version includes three columns of “Name”, “URL”, and “Time”, and a new version includes a column of “Flag Information” as a difference area in addition to the above three columns. When a conversion process is performed on the new version of data, a post-conversion character string generated from information data stored in the column of “Flag Information” is embedded in the column of “Name”. When an inverse conversion process is performed on the old version of data, the column of “Flag Information” is restored from embedded data embedded in the column of “Name”.

FIG. 19(B) shows data format information of history information used in an e-mail application. When history information is set as target data, an old version includes five columns of “From”, “To”, “Time”, “Subject”, and “Text”, and a new version includes a column of “Flag Information” as a difference area in addition to the above five columns. When a conversion process is performed on the new version of data, a post-conversion character string generated from information data stored in the column of “Flag Information” is embedded in the column of “Subject” or “Text”. When an inverse conversion process is performed on the old version of data, the column of “Flag Information” is restored from embedded data embedded in the column of “Subject” or “Text”.

FIG. 19(C) shows data format information of a schedule book used in a schedule application. When a schedule book is set as target data, an old version includes two columns of “Time” and “Subject”, and a new version includes columns of “Place” and “Partner” as difference areas in addition to the above two columns. When a conversion process is performed on the new version of data, post-conversion character strings generated respectively from information data stored in the columns of “Place” and “Partner” are embedded in the column of “Subject”. When an inverse conversion process is performed on the new version of data, the columns of “Place” and “Partner” are restored from embedded data embedded in the column of “Subject”.

In addition, in each embodiment, each of the respective functional blocks of the data conversion device is realized as a program that runs on a CPU, but some or all of the functions may be realized as an LSI, which is an integrated circuit. These functional blocks may be individually formed on a chip, or some or all of the functional blocks may be integrated on a chip. These LSIs may be referred to as ICs, system LSIs, super LSIs, or ultra LSIs depending on the degree of integration. Moreover, a technique of integrated circuit implementation is not limited to the LSI, but may be achieved by a dedicated circuit or a universal processor. An FPGA (FIELD PROGRAMMABLE GATE ARRAY) which is programmable after production of an LSI, and a reconfigurable processor in which the connection and the setting of circuit cells within the LSI are reconfigurable, may be used. Furthermore, needless to say, if a technique of integrated circuit implementation, which replaces the LSI, appears as a result of advancement of the semiconductor technique or another technique derived therefrom, function blocks may be integrated by using the technique. Adaptation of a bio technique could be one possibility.

### Other Embodiments

In each embodiment described above, whether to perform the conversion process or the inverse conversion process may be determined on the basis of an input of the user. For example, after receiving processing target data, the information apparatus displays an icon for input of the user. The user is allowed to recognize a difference between data formats of different versions on the screen, and thus is allowed to select either the conversion process or the inverse conversion process by using the icon for input.

In each embodiment described above, the data conversion device may acquire data format information via a network after receiving an instruction for the conversion process or the inverse conversion process. In this case, it is possible to omit the version information storage section.

### INDUSTRIAL APPLICABILITY

The data conversion device according to the present disclosure is useful for information apparatuses having a communication function, such as PCs, mobile phones, smart phones, tablet terminals, digital cameras, and portable music players, and AV apparatuses such as televisions, AV players, and HDD recorders.

### DESCRIPTION OF THE REFERENCE CHARACTERS

1, 2, 3, 4, 5 information apparatus
6 network
10 CPU
20 memory device
21 ROM
30 communication device
31 portable storage medium
32 read/write device
40 input device
45 display device
50 bus line
100 information apparatus A
200 information apparatus B
101, 201 communication section
102, 202 processing section
103, 203 DBMS
104, 204 data storage section
110, 130 data conversion device
111 control section
112 version information storage section
113 conversion section
114 inverse conversion section
115 code storage section
120 information apparatus
122 second processing section
131 second control section
132 second version information storage section

1. A data conversion device which converts processing target data to another version whose data format is different from that of the processing target data, the data conversion device comprising:
a code storage section configured to store therein a conversion rule which uses codes for non-display characters to which no character is allocated;
a conversion section configured to perform, when an information storing area included only in a first data format among the first data format corresponding to an input version which is a version of the processing target data and a second data format corresponding to an output version to which the processing target data is converted by the data conversion device is present as a difference area, a conversion process of converting information data stored in the difference area in the processing target data to a post-conversion character string using the codes for the non-display characters, on the basis of the conversion rule, and generating post-conversion data of the output version in which the post-conversion character string is embedded;
an inverse conversion section configured to perform, when an information storing area included only in the second data format among the first data format and the second data format is present as a difference area, an inverse conversion process of inversely converting a character string that is embedded in the processing target data and uses the codes for the non-display characters, on the basis of the conversion rule, and then generating post-inverse conversion data of the output version in which information data restored by the inverse conversion is stored in the difference area; and
a control section configured to control the conversion section and the inverse conversion section.

2. The data conversion device according to claim 1, wherein the control section instructs the conversion section to perform the conversion process when the control section determines execution of the conversion process on the basis of the input version; and instructs the inverse conversion section to perform the inverse conversion process when the control section determines execution of the inverse conversion process on the basis of the input version.

3. The data conversion device according to claim 1, further comprising a version information storage section configured to store therein data format information indicating the first data format, wherein
the data format information includes embeddability information indicating whether it is possible to embed the post-conversion character string, and
when the control section determines, on the basis of the embeddability information, that it is impossible to embed the post-conversion character string, the control section does not instruct the conversion section to perform the conversion process.

4. The data conversion device according to claim 1, wherein, in the conversion process, the conversion section embeds the post-conversion character string in an information storing area in which, by a target program which generates, on the basis of the processing target data, an image to be displayed on a screen, information data used only for generating information on the image based on the processing target data is stored.

5. The data conversion device according to claim 1, wherein the control section compares the input version and the output version to each other, instructs the conversion section to perform the conversion process when the input version is newer than the output version, and instructs the inverse conversion section to perform the inverse conversion process when the input version is older than the output version.

6. The data conversion device according to claim 1, further comprising a version information storage section configured to store therein data format information indicating the first data format and data format information indicating the second data format, wherein
in the conversion process, the conversion section converts information data extracted from the difference area in the processing target data by using each of the data format information stored in the version information storage section, to the post-conversion character string.

7. The data conversion device according to claim 1, further comprising a version information storage section configured to store therein data format information indicating the first data format and data format information indicating the second data format, wherein
in the inverse conversion process, the inverse conversion section inversely converts a character string that is extracted from the processing target data by using each of the data format information stored in the version information storage section and uses the codes for the non-display characters.

8. The data conversion device according to claim 3, wherein
the processing target data is data in a database format, and
the version information storage section stores therein data format information of the database format including one or more columns, and the data format information includes the embeddability information for each column.

9. The data conversion device according to claim 1, wherein the code storage section stores therein, as the conversion rule, a code conversion table in which the codes for the non-display characters and binary number strings correspond to each other.

10. The data conversion device according to claim 1, wherein, when the processing target data is bookmark information used in a program for browsing through a web browser, the conversion section embeds the post-conversion character string in an information storing area in which data of a title of a web page in the bookmark information is stored.

11. The data conversion device according to claim 1, wherein, when the processing target data is history information used in a program for browsing through a web browser, the conversion section embeds the post-conversion character string in an information storing area in which data of a title of a web page in the history information is stored.

12. The data conversion device according to claim 1, wherein, when the processing target data is schedule information used in a schedule management program, the conversion section embeds the post-conversion character string in an information storing area in which data of a matter or a task in the schedule information is stored.

13. The data conversion device according to claim 1, wherein, when the processing target data is e-mail history information used in an e-mail program, the conversion section embeds the post-conversion character string in an information storing area in which data of a subject or an e-mail text in the e-mail history information is stored.

14. The data conversion device according to claim 1, wherein, when the processing target data is schedule information used in a program for schedule management, the conversion section embeds the post-conversion character string in an information storing area in which a subject of a schedule in the schedule information is stored.

15. An information apparatus comprising:
the data conversion device according to claim 1; and
a processing section configured to instruct the data conversion device to perform the conversion process and to perform the inverse conversion process.

16. The information apparatus according to claim 15, wherein
the data conversion device further comprises a version information storage section configured to store therein data format information indicating a data format of a self-apparatus version which is used by the self-apparatus, and
when the control section receives an instruction for the conversion process on the processing target data from the processing section, the control section extracts information data in the difference area from the processing target data by using the processing target data and the data format of the self-apparatus version, and instructs the conversion section to perform the conversion process on the extracted information data.

17. The information apparatus according to claim 15, wherein
the data conversion device further comprises a version information storage section configured to store therein data format information indicating a data format of a self-apparatus version which is used by the self-apparatus, and
when the control section receives an instruction for the inverse conversion process on the processing target data from the processing section, the control section extracts an entirety of a character string using the non-display characters, as embedded data from the processing target data, and instructs the inverse conversion section to perform the inverse conversion process on the extracted embedded data.

18. A data conversion method for converting processing target data to another version whose data format is different from that of the processing target data, the data conversion method comprising:
a conversion step of, when an information storing area included only in a first data format among the first data format corresponding to an input version which is a version of the processing target data and a second data format corresponding to an output version to which the processing target data is converted by the data conversion method is present as a difference area, converting, on the basis of a conversion rule which uses codes for non-display characters to which no character is allocated, information data stored in the difference area in the processing target data to a post-conversion character string using the codes for the non-display characters, and generating post-conversion data of the output version in which the post-conversion character string is embedded; and
an inverse conversion step of, when an information storing area included only in the second data format among the first data format and the second data format is present as a difference area, inversely converting a character string that is embedded in the processing target data and uses the codes for the non-display characters, on the basis of the conversion rule, and then generating post-inverse conversion data of the output version in which information data restored by the inverse conversion is stored in the difference area.

19. A non-transitory computer-readable recording medium having a program recorded thereon, the program causing a computer to perform a data conversion process of converting processing target data to another version whose data format is different from that of the processing target data, the program causing the computer to execute:
a conversion step of, when an information storing area included only in a first data format among the first data format corresponding to an input version which is a version of the processing target data and a second data format corresponding to an output version to which the processing target data is converted by the data conversion process is present as a difference area, converting, on the basis of a conversion rule which uses codes for non-display characters to which no character is allocated, information data stored in the difference area in the processing target data to a post-conversion character string using the codes for the non-display characters, and generating post-conversion data of the output version in which the post-conversion character string is embedded; and
an inverse conversion step of, when an information storing area included only in the second data format among the first data format and the second data format is present as a difference area, inversely converting a character string that is embedded in the processing target data and uses the codes for the non-display characters, on the basis of the conversion rule, and then generating post-inverse conversion data of the output version in which information data restored by the inverse conversion is stored in the difference area.
